(19) United States
(12) Patent Application Publication
(10) Pub. No.: US 2006/0047552 A1
(43) Pub. Date: Mar. 2, 2006

(54) Smart appointment recall method and apparatus

(75) Inventors: Steven J. Larsen, Cross Plains, WI (US); Christopher C. Spotts, McFarland, WI (US)

Correspondence Address: QUARLES & BRADY LLP, 411 E. WISCONSIN AVENUE, SUITE 2040, MILWAUKEE, WI, 53202-4497, US

(73) Assignee: Epic Systems Corporation

(21) Appl. No.: 11/134,175

(22) Filed: May 20, 2005

Related U.S. Application Data
(60) Provisional application No. 60/603,866, filed on Aug. 24, 2004.

(51) Int. Cl. G06F 9/46

(52) U.S. Cl. 705/8

(57) ABSTRACT

A method and apparatus for use with a resource scheduling system that includes a schedule that associates resource time slots with scheduled client matters and associates scheduled recall procedures with schedule times, each scheduled recall procedure for generating at least one recall notice at a corresponding schedule time indicating a possible client matter to be scheduled, each of the scheduled client matters and scheduled recall procedures being a scheduled item, the schedule including scheduled item information associated with each of the scheduled items, the method for facilitating schedule management and comprising the steps of receiving recall information for a possible recall procedure that may be scheduled, comparing the received recall information with at least a subset of the scheduled item information to identify at least one scheduled item that may be related to the possible recall procedure and performing a scheduling process as a function of the at least one identified scheduled item.

### CROSS-REFERENCE TO RELATED APPLICATIONS

This patent is related to provisional patent application 60/603,866 that is titled “Smart Appointment Recall Method and Apparatus” and that was filed on Aug. 24, 2004.

### STATEMENT REGARDING FEDERALLY SPONSORED RESEARCH OR DEVELOPMENT

Not applicable.

### BACKGROUND OF THE INVENTION

This invention relates generally to resource scheduling systems and more specifically to methods and apparatus for scheduling future appointments for medical patients when additional or routine appointments with a physician or the like are desired.

Hereinafter, unless indicated otherwise, the term “physician” will be used in a general sense to refer to any professional that performs a medical procedure/test on a patient including but not limited to doctors, nurses, nurses aides, orderlies, etc. In addition, the phrase “medical facility” will be used hereafter to refer generally to any medical facility at which physicians work including but not limited to hospitals, physician offices, remote/portable offices, clinics, etc.

In addition, it should be appreciated that, while the present invention is described in the context of a medical facility and medical services, the invention is not meant to be so limited. Instead, the invention may be applicable in any of several different industries wherein resources (i.e., physician time, medical equipment, maintenance equipment, etc.) are scheduled for use and where notices are generated periodically to remind a scheduler or a client that periodic procedures or encounters or check-ups should be scheduled to be performed.

People have routine and therefore schedulable medical needs. For example, children usually have checkups with a family physician to make sure physical development is on track, to receive shots, etc. As another example, men in their fifties and thereafter usually participate in routine screenings designed to detect symptoms of certain cancers that generally afflict elder men more than younger men. When routine medical appointments occur, typically routine tests and procedures are performed such as physical examination for unusual symptoms, various imaging procedures, diagnostic tests such as blood work and urine analysis, etc.

In addition to routine medical needs, people often get sick or injured between routinely scheduled visits to a doctor and therefore make unexpected appointments to diagnose unexpected conditions and to prescribe remedies. For instance, assume that a person routinely schedules a physical at the beginning of January and at the beginning of July each year (i.e., every six months). In this case, if the person gets sick in mid-June, the person may schedule an unexpected appointment to see her physician for diagnosis and a remedy.

When an unexpected doctor's visit occurs to address symptoms, the attending physician may order several diagnostic tests and procedures selected to help identify the cause of the ailment. For example, the tests and procedures may include a general physical examination, various imaging procedures, diagnostic tests such as blood work and urine analysis, etc. In addition, in at least some cases, physicians require follow up or recall appointments (hereinafter “recalls”) either with the diagnosing physician or, where symptoms are particularly disconcerting, with one or more specialists and the physician and/or specialist performs additional tests and procedures to diagnose medical conditions.

While routine and unscheduled appointments undeniably have many advantages including identification of physical problems at an early and typically treatable stage, patients are typically interested in keeping the number of appointments with physicians to a minimum for several reasons. First, medical procedures take time. Most people have extremely full schedules and do not want to take time out of their usual routines for medical procedures/tests unless absolutely necessary.

Second, many medical procedures make patients uncomfortable or even cause pain. Because most people try to avoid discomfort and pain, most people seek to limit the number of uncomfortable/painful medical procedures they have to endure.

Third, in many cases patients have to pay at least part if not all of certain medical bills due to insurance cut backs and reductions. Here, out of pocket patient costs can be minimized by reducing the quantity of services received (i.e., reducing the number of physician appointments). For the same reasons, most patients want to avoid having duplicative tests and procedures performed.

Several different tools have been developed to help physicians manage their schedules including software based scheduling systems as well as software based recall systems. With respect to scheduling systems, most medical facilities now employ one or more scheduling interfaces that run scheduling software that enables scheduling employees (hereinafter a “scheduler”) to keep track of physician time and patient appointments. To this end, where several physicians work at a single medical facility, known scheduling software typically includes a graphical time and date table for each facility physician where the table is usually populated with appointments for each physician and indicates open times between appointments during which additional patient appointments can be scheduled.

To schedule an appointment, the scheduler uses the interface (i.e., a mouse, a keyboard, etc.) to select one of the open schedule time slots for the appointment and inputs information about a patient for which the appointment is to be made including, for instance, sex, age, symptoms, what the appointment is for (i.e., blood work, routine checkup, imaging, colonoscopy, vaccinations, etc.) etc. After the patient information is entered, the next time the scheduler views the schedule, the time slot associated with the new appointment is shown in the graphic schedule table as unavailable or taken.

In addition to providing schedule tables and interface tools for populating the tables, at least some scheduling software is equipped to at least suggest scheduling preferences where appropriate. For example, assume both physicians A and B work out of the same facility, that a patient already has a scheduled appointment with physician A to address a first condition and that the patient is now attempting to schedule a second appointment with physician B to address a second condition. In this case, assuming that the second condition is not urgent, when the scheduler attempts to schedule the appointment with physician B, the scheduling software may identify the already existing appointment with physician A and suggest that the second appointment be scheduled during a time slot either just before or just after the appointment with physician A. The scheduler is free to select the suggested time slot or to select any other open time slot for scheduling the second appointment. Assuming that the patient's schedule allows the patient to attend the second appointment during the suggested time slot, that time slot would likely be preferable as the patient could attend two appointments during a single visit to the medical facility. Hereinafter this scheduling feature that suggests optimal scheduling time slots will be referred to as a “grouping” feature.

With respect to software based recall systems, while patients and/or physicians may want to schedule regular medical appointments or call backs for a variety of reasons (e.g., routine checkups, as a follow up to a previous examination, etc.), often patients are not in a position to schedule a recall at the time of a previous appointment. For instance, while a woman may have a physical every six months generally at the beginning of January and at the beginning of July, as the woman is leaving a January physical, the woman may not be able to commit to a specific time at the beginning of the following July to attend the next physical due to vacation scheduling or the like and may prefer to wait until a few weeks before the beginning of July to schedule the next physical.

In this and other cases, a recall system is designed to provide reminders to patient's when next appointments should be scheduled. In the above example where the woman's next physical should be some time in early July, a recall system may either prompt a scheduler to send a recall letter to the woman or generate an automatic recall notice to be sent to the woman some time in early June (e.g., four weeks prior to a desired time for the appointment) so that the woman can make the appointment at a suitable time. Here, the process run by the software to generate a recall notice is referred to generally as a “recall procedure” and the date approximating the time at which a recall appointment is to be scheduled is referred to as a “target date”.

Recall procedures are typically scheduled in one of two different ways. First, recall procedures are manually scheduled by a scheduler such as, for instance, when a physician requires a one month follow up visit after placing a patient on a specific drug to address certain symptoms. Second, some systems generate automatic recall procedures for routine periodic appointments thereby reducing the scheduling burden placed on the scheduler. For instance, where typical care requires that all male patients over 60 years of age require a specific cancer screening every six months, the recall system may be programmed to automatically schedule recall procedures with target dates that occur every six months. Here, recall notice can be generated in any of several different forms including a letter, a post card, an e-mail, posting on a personal medical web portal, a voice mail, a personal phone call, etc.

When a recall procedure is scheduled, if an appointment associated therewith is subsequently scheduled, the scheduler has to independently make the association between the scheduled appointment and the recall procedure and has to manually cancel the recall procedure to avoid sending the notice.

While scheduling and recall systems of the above kinds have several advantages, they also have several shortcomings that can lead to duplicative procedures, non-optimal scheduling and patient confusion. For example, assume that a first recall procedure is already scheduled for a patient to generate notice of an appointment that is routinely conducted every six months and that the target date for the recall procedure is a first date. Also assume that the patient is injured two months before a target date and that a physician attending to the patient's injuries requires a recall appointment having a target date two weeks after the first date at which the attending physician intends to perform a general physical on the patient along with some additional medical procedures.

To schedule the required recall procedure, the scheduler uses the recall system to set up a second recall procedure having the target date specified by the attending physician. The end result here is that two recall procedures are scheduled for at least similar and generally contemporaneous appointments. Assuming that all recall notices are sent out one month prior to target dates, in the present example the patient receives a recall notice corresponding to the first recall procedure and a second notice corresponding to the second recall procedure where the notices are spaced two weeks apart.

At the very least the two notices would cause patient confusion. More importantly, the two notices could result in two appointments for similar or, in some cases, the same procedures and tests. This duplicative appointment problem is particularly likely where different physicians are slated to perform the similar procedures. The end result is duplicative medical activities and confusion.

As another example, assume a recall procedure is scheduled and that an appointment associated therewith is scheduled prior to the recall procedure being performed (i.e., prior to the recall notice being generated). If the scheduler fails to identify that the scheduled appointment is related to the scheduled recall procedure, the scheduled recall procedure will be performed and a notice will be sent to the patient. Here, when the patient receives the recall notice after the appointment has already been scheduled, again, confusion will result.

In some cases the patient may not recognize the duplicative nature of the scheduled appointment and the appointment associated with the recall procedure or may assume that the scheduled appointment was cancelled for some reason and may therefore attempt to schedule an appointment pursuant to the recall notice. When making the appointment pursuant to the recall notice, if the scheduler does not recognize the duplicative nature of the scheduled appointment and the appointment being made pursuant to the recall notice, duplicative appointments may result. Similar confusion and duplicative scheduling can result when an appointment is scheduled prior to a recall procedure being scheduled and performed.

As another example, assume that first, second and third recall procedures are currently scheduled for a single patient where the first and second procedures are separated by one week and the second and third procedures are separated by two weeks, that all recall notices are sent out four weeks prior to associated target dates and that the first, second and third notices are to provide notice of appointments that are required to address different conditions (i.e., the appointments are for non-duplicative medical activities). In addition, assume that during days temporally proximate the target date associated with the first recall procedure, when the first recall procedure is performed (e.g., four weeks before the associated target date), there are several instances when three consecutive time slots are open during which the three appointments could be performed consecutively so that the patient would only have to visit the facility once to attend all three appointments.

In this case, first, second and third separate recall notices are sent to the patient where the first notice precedes the second by one week and the second precedes the third by two weeks. Assuming a diligent patient, when the first notice is received, the patient may immediately schedule a first appointment during a first time slot.

When the second notice is received, the patient may call a facility scheduler to schedule a second appointment during a second time slot. Here, assuming that the scheduling system supports a grouping feature (i.e. is programmed to suggest optimal time slots that group new appointments to be scheduled with existing scheduled appointments), when the patient calls to schedule the second appointment, the system may be able to suggest a time slot for the second appointment to the scheduler that is consecutive with the first time slot assuming that a consecutive time slot is still open. However, it may be that none of the time slots that are consecutive with the first time slot remain open and therefore the second appointment may have to be scheduled at a different time and require a second visit to the facility.

When the third notice is received, the patient may again call the scheduler to schedule a third appointment during a third time slot. Here, grouping the third appointment with the first and second appointments is much more difficult if not impossible without rescheduling the first and second appointments as the likelihood that a third time slot consecutive with the time slots associated with the first and second appointments is still open would be minimal at best. In many cases the complexity of rescheduling would render that option impractical and the patient would be required to make at least two if not three visits to the facility to attend the three appointments.

As still one other example assume that a first appointment is already scheduled for a first time slot to address a first condition and that a recall procedure to generate a scheduling notice for a second appointment to address a second condition has a target date that is within two weeks of the first time slot. Also assume that when the recall procedure is performed a second time slot that is consecutive with the first time slot is open which would be ideal for the second appointment. Here, if the patient receives a simple notice that the second appointment should be scheduled, the patient may wait a few weeks to schedule the second appointment at which time the second time slot could and, likely would, be filled, thereby resulting in sub-optimal scheduling. Again, the option would be to either accept sub-optimal scheduling or to reschedule the first appointment along with the second appointment.

Thus, it would be advantageous to have a system that could help to eliminate duplicative recall procedures and recall procedures for appointments that have already been scheduled and that could suggest optimal scheduling preferences when several recall procedures have similar target dates or when one or more recall procedures have target dates that are similar to time slots of already scheduled appointments.

### BRIEF SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

It has been recognized that many of the problems described above can be addressed by comparing recall procedure information prior to performing recall procedures and identifying recall procedures that are either possibly duplicative of other scheduled recall procedures or that are possibly duplicative of scheduled patient/client appointments or matters and then eliminating duplicative recall procedures where appropriate.

It has also been recognized that scheduling confusion can be minimized and scheduling efficiency or optimization can be increased by providing composite recall notices where appropriate that identify temporally proximate recall target dates and scheduled appointment times and provide one or a reduced number of notices to patients where the notice(s) indicates all temporally proximate target dates and appointments. Moreover, it has been recognized that scheduling optimization can further be increased by identifying resource availability prior to transmitting recall notices and suggesting possible time slots for future appointments that need to be scheduled.

Consistent with the above comments, at least some embodiments of the present invention include a method for use with a resource scheduling system that includes a schedule that associates resource time slots with scheduled client matters and associates scheduled recall procedures with schedule times, each scheduled recall procedure for generating at least one recall notice at a corresponding schedule time indicating a possible client matter to be scheduled, each of the scheduled client matters and scheduled recall procedures being a scheduled item, the schedule including scheduled item information associated with each of the scheduled items, the method for facilitating schedule management and comprising the steps of receiving recall information for a possible recall procedure that may be scheduled, comparing the received recall information with at least a subset of the scheduled item information to identify at least one scheduled item that may be related to the possible recall procedure and performing a scheduling process as a function of the at least one identified scheduled item.

In at least some cases the step of comparing includes identifying at least one scheduled item that is associated with scheduled item information that is similar to the received recall information. In some cases the method further includes the step of providing an interface and wherein the step of performing a scheduling process includes indicating the identified scheduled item via the interface. In some cases the step of providing an interface includes providing an input device enabling an interface user to indicate that the possible recall procedure is duplicative with the at least one identified scheduled item. Some embodiments further include the steps of receiving an indication that the possible recall procedure is duplicative with the at least one identified scheduled item and updating the schedule so that a single scheduled item is included in the schedule for the at least one scheduled item and the possible recall procedure.

In some embodiments the step of updating the schedule includes, where the identified scheduled item is a scheduled client matter, one of replacing the scheduled client matter with a recall procedure in the schedule and maintaining the scheduled client matter in the schedule. The step of updating may include, where the identified scheduled item is a scheduled recall procedure, one of replacing the scheduled recall procedure with a recall procedure at a different schedule time and maintaining the scheduled recall procedure in the schedule.

According to another aspect the step of comparing may include identifying a plurality of scheduled items where each identified scheduled item is associated with information that is similar to the received information and wherein the step of performing a scheduling process includes performing a scheduling process as a function of the plurality of identified scheduled items. Here, the method may further include the step of providing an interface and the step of performing a scheduling process may include displaying the identified scheduled items via the interface.

In at least some cases the step of providing an interface includes providing an input device enabling an interface user to indicate that the possible recall procedure is duplicative with at least one identified scheduled item. Some cases further include the step of receiving an indication that the possible recall procedure is duplicative with at least one of the identified scheduled items and updating the schedule so that a single scheduled item is included in the schedule for the at least one of the scheduled items and the possible recall procedure.

In some cases the method further includes the step of identifying probabilities that each of at least a subset of the identified scheduled items is related to the possible recall procedure and wherein the step of performing a scheduling process includes performing a scheduling process that is also a function of the probabilities. Here, the method may further include the step of providing an interface and the step of performing a scheduling process may include displaying at least the subset of the scheduled identified items that are most possibly related via the interface. Also, here, the method may further include the step of providing an interface and the step of performing a scheduling process may include displaying at least a subset of the scheduled items in a manner that visually distinguishes each item in the subset as a function of associated probabilities.

In some cases the step of displaying each item in the subset in a visually distinguishing manner includes expressing the probabilities in relative percentages. In some cases the probabilities are determined as a function of the comparison of the received information and the information associated with the scheduled items.

The step of receiving recall information may include receiving a time associated with the possible recall procedure and the probabilities may be determined at least in part as a function of a comparison of the received time and at least one of the time slots associated with the scheduled client matters and the times associated with the scheduled recall procedures.

In some embodiments the step of comparing includes identifying a single scheduled item and the step of performing a scheduling procedure includes associating the received information with the single scheduled item and automatically updating the schedule so that a single schedule item is included in the schedule for the identified scheduled item and the possible recall procedure pair.

Some embodiments further include the step of providing a scheduling interface, the step of receiving including receiving the recall information via the interface, the step of performing a scheduling process including, when a scheduled item is identified, presenting a query via the interface requesting an interface user to indicate if the possible recall procedure may be duplicative with the identified scheduled item.

In some cases the scheduling process further includes receiving an indication via the interface. Here, where the received indication indicates that the possible recall procedure is duplicative, the method may include allowing only one instance of the possible recall procedure and the scheduled item in the schedule and, where the received indication indicates that the possible recall procedure is other than duplicative, facilitating scheduling of the possible recall procedure in addition to the scheduled item.

When the identified scheduled item is a scheduled recall procedure, the step of facilitating scheduling of the possible recall procedure in addition to the scheduled item may include combining the possible recall procedure and the identified scheduled recall procedure so that a single notice is generated for both the identified and possible recall procedures. Here, the step of combining may include generating a single notice that identifies both a possible client matter associated with the identified scheduled recall procedure and a possible client matter associated with the possible recall procedure.

In some embodiments the step of receiving recall information includes providing a rule set for automatically generating recall notices as a function of client characteristics (e.g., age, sex, previous procedures, medical history, family history, genetics, etc.), comparing client information to the rule set and generating recall information as a function of the comparison. In some embodiments the step of receiving recall information includes receiving a schedule time for the possible recall procedure, the step of comparing the received recall information including identifying scheduled client matters and recall procedures having time slots and times, respectively, that are within a time period of the received schedule time. Here, the step of performing a scheduling process may include combining the possible recall procedure with temporally proximate recall procedures. The step of performing a scheduling process may also includes generating a recall notice that, in addition to indicating possible client matters for each of the recall procedures, also identifies at least one temporally proximate scheduled client matter.

In some cases the step of performing at least a portion of a scheduling process includes providing a notice identifying the at least one identified item and wherein the notice is provided as one of an electronic message, a printed message and a voice message.

In some cases the received information corresponds to a first client and the first client is related to at least a second client (i.e., mother—child relationship), the step of comparing the received recall information with at least a subset of the scheduled item information to identify at least one scheduled item that may be related to the possible recall procedure including comparing the received information to scheduled item information for each of the first and second clients.

The method may further include providing an interface wherein the step of performing a scheduling process includes presenting at least a subset of the identified scheduled client matters and scheduled recall procedures via the interface.

Other embodiments of the invention include a method for use with a resource scheduling system that includes a schedule that associates resource time slots with scheduled client matters and associates scheduled recall procedures with schedule times, each scheduled recall procedure for generating at least one recall notice for an associated possible client matter at a corresponding schedule time, the schedule including scheduled recall procedure information associated with each of the scheduled recall procedures, the method for facilitating schedule management and comprising the steps of receiving scheduling information for a client matter to be scheduled, comparing the received scheduling information with at least a subset of the scheduled recall procedure information to identify at least one scheduled recall procedure that may be related to the client matter to be scheduled and performing a scheduling process as a function of the at least one identified scheduled recall procedure.

Still other embodiments include a method for use with a resource scheduling system that includes a schedule that associates resource time slots with scheduled client matters and associates scheduled recall procedures with schedule times, each scheduled recall procedure for generating at least one recall notice for an associated possible client matter at a corresponding schedule time, each of the scheduled client matters and scheduled recall procedures being a scheduled item, the schedule including scheduled item information associated with each of the scheduled items, the method for facilitating schedule management and comprising the steps of for a specific recall procedure, comparing item information with item information associated with the at least a subset of the scheduled items to identify other scheduled items that may be related to the specific recall procedure and performing a scheduling process as a function of any identified other schedule items.

In some cases a specific time is associated with the specific recall procedure and the step of comparing may include comparing the item information for the specific recall procedure with item information associated with other schedule items that are temporally proximate the specific recall procedure. Here, temporally proximate may include other scheduled items within two weeks of the specific time. Here, temporally proximate may also include other scheduled items within two days of the specific time.

The method may further include the step of providing an interface and the step of performing a scheduling process may include providing a list of the identified scheduled items via the interface. The steps of comparing and performing may be performed when item information for the specific recall procedure is initially created. In the alternative when a specific time is associated with the specific recall procedure and the steps of comparing and performing may be performed when the specific time occurs. In other cases, the steps of comparing and performing may be performed on each of the scheduled recall procedures periodically in batch.

Other embodiments include a method for use with a resource scheduling system that includes a resource schedule that associates schedule times for the resource with scheduled client matters and associates scheduled recall procedures with schedule times, each scheduled recall procedure for generating at least one recall notice for an associated possible client matter at a corresponding schedule time, each of the scheduled client matters and scheduled recall procedures being a scheduled item, the method for facilitating schedule management and comprising the steps of for a specific recall procedure associated with a specific time, identifying other scheduled items that are associated with times that are temporally proximate the specific time and generating at least one recall procedure notice as a function of the identified scheduled items.

When at least one of the identified scheduled items is a recall procedure in addition to the specific recall procedure, the step of generating a notice may include generating a single notice for both of the specific recall procedure and the identified recall procedure. The method may also include limiting the schedule to include only one of the specific and identified recall procedures. When at least one of the identified scheduled items is a scheduled client matter, the step of generating a notice may include generating a notice that indicates that a possible client matter associated with the specific recall procedure is temporally proximate an existing scheduled client matter.

Some embodiments include a method for use with a resource scheduling system that includes a schedule that associates resource time slots with scheduled client matters and associates scheduled recall procedures with schedule times, each scheduled recall procedure for generating at least one recall notice for an associated possible client matter at a corresponding schedule time, the schedule including scheduled recall procedure information associated with each of the scheduled recall procedures, the method for facilitating schedule management and comprising the steps of, for a specific client matter, comparing item information with item information associated with the at least a subset of scheduled recall procedures to identify recall procedures that may be related to the specific client matter and performing a scheduling process as a function of any identified scheduled recall procedures.

At least some embodiments of the invention include a method for use with a recall system that processes recall procedures, each recall procedure generating at least one recall notice for an associated possible client matter at a corresponding schedule time, the method for use with an electronic network including at least one interface and comprising the steps of transmitting at least one recall notice to the interface, examining the recall notice via the interface, using the interface to indicate that a matter associated with the recall procedure has likely been completed and performing a scheduling function in response to the indication that the matter associated with the recall procedure has been completed. Here, the scheduling function may include obtaining authorization via the interface to obtain a confirmation record regarding the completed matter. In some cases the scheduling function includes storing an indication that the matter associated with the recall procedure has been completed. In some cases the step of using the interface includes providing information regarding the completed matter associated with the recall procedure.

Apparatus are also contemplated for performing the methods described above and in this specification generally wherein an exemplary apparatus includes a processor for performing the methods, a database for storing data and programs required by the processor, an interface/input device and a display/output device. Networked apparatus and components are also contemplated.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a schematic diagram illustrating an exemplary scheduling system according to at least some aspects of the present invention;

FIG. 2 is an exemplary window showing a simplified physician's schedule and various input tools according to at least some aspects of the present invention;

FIG. 3 is a simplified and exemplary scheduling screen window view that may be provided via the interface of FIG. 1;

FIG. 4 is a similar to FIG. 3, albeit illustrating a recall creation window view according to some embodiments of the present invention;

FIG. 5 is an exemplary schedule database that may be used with the system of FIG. 1;

FIG. 6 is an exemplary recall database that may be used with the system of FIG. 1;

FIG. 7 is a schematic illustrating a composite recall notice that suggests optimal scheduling times for appointments to be scheduled in the future and that provides scheduling interface icons; and

FIG. 8 is a flowchart illustrating one recall duplicate identifying method that occurs as a recall procedure is being created;

FIG. 9 is a recall warning window that may be provided to indicate that a recall procedure being created may be related to a scheduled recall procedure;

FIG. 10 is similar to FIG. 4, albeit illustrating a recall creation screen including specifying information that specifies a different recall procedure;

FIG. 11 is a recall warning window that may be provided to indicate that a recall procedure being created may be related to an already scheduled appointment or patient/client matter;

FIG. 12 is a recall warning window that may be provided to indicate two scheduled recall procedures and percentage probabilities that each of those two procedures is related to a recall procedure being created;

FIG. 13 is a flowchart illustrating a method whereby newly scheduled appointments are compared to existing scheduled recall procedures so that recall procedures related to the newly scheduled appointments can be identified and removed from a schedule;

FIG. 14 is a recall warning window that may be generated when a server automatically creates recall procedures via a recall engine and when an automatically generated recall procedure is possibly related to a previously scheduled recall procedure;

FIG. 15 is a flowchart illustrating a duplicate recall procedure identifying method where the method occurs when a recall procedure is to be performed as opposed to when the recall procedure is being created;

FIG. 16 is a recall warning window that may be provided including tools for canceling a subset of possibly related scheduled items;

FIG. 17 is a flowchart of a subprocess that may be substituted for a portion of the process of FIG. 9 for generating combined recall notices;

FIG. 18 is an exemplary composite electronic recall notice that may be transmitted to a patient via a computer network;

FIG. 19 is similar to FIG. 7, albeit including additional functional icons; and

FIG. 20 is a window requesting completed matter information from a client.

### DETAILED DESCRIPTION OF THE INVENTION

One or more specific embodiments of the present invention will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Hereinafter, unless indicated otherwise, the present inventions will be described in the context of Saint Mary's Hospital, an exemplary medical facility, at which a plurality of physicians work. In addition, hereafter, the inventions will be described in the context of a simplified information system that keeps track of physician schedules and recall procedures for specific patients of the medical facility in order to simplify this explanation. Nevertheless, it should be appreciated that the inventions are intended to be used with simple as well as much more complex information systems. For example, while the inventions are described herein in the context of a system including a single scheduling server, it is contemplated that more than one server may maintain physician schedules and may be linked via the internet or the like. Similarly, while the information system is described in context of a single medical facility, it should be appreciated that the system may be employed where a plurality of related medical facilities cooperate to provide services and where the scheduling functions are provided across related facilities. As another example, while the simplified system is described as including a single scheduling interface and a single patient interface hereafter, it should be appreciated that many different interfaces may be employed for scheduling and that a large number of patient interfaces are contemplated.

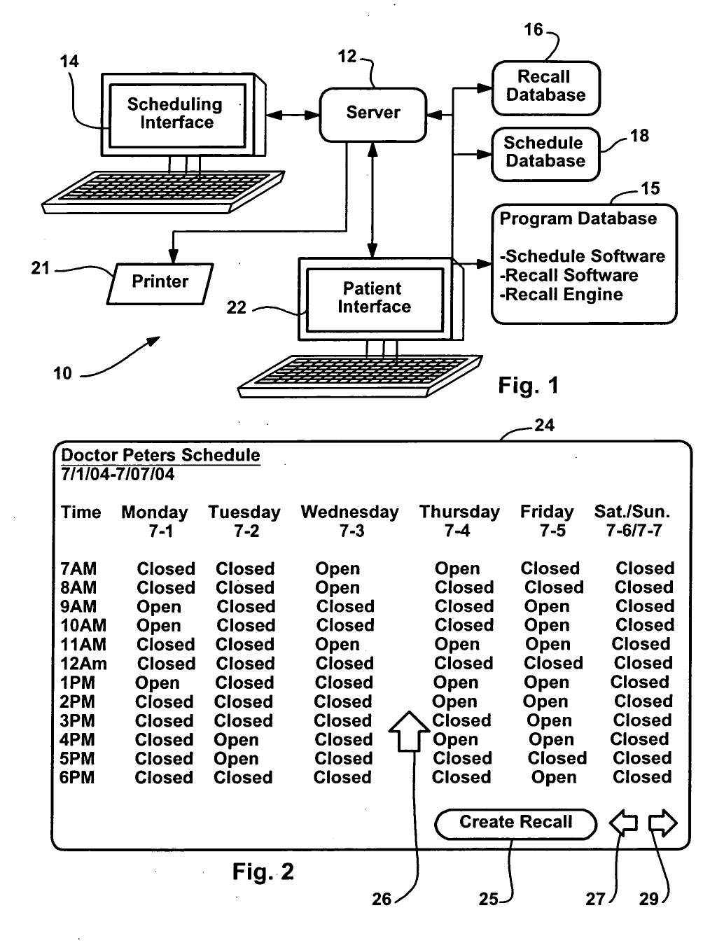

Referring now to the drawings wherein like reference numerals correspond to similar elements throughout the several views and, more specifically, referring to FIG. 1, the inventions will be described in the context of exemplary scheduling system 10 which includes a server 12, a scheduling interface 14, a program database 15, a recall database 16 and a schedule database 18. In addition, as illustrated, in at least some embodiments of the present invention, system 10 will also include one or both of a printer 21 and a patient interface 22.

Server 12 includes one or more high speed processors that run various programs to carry out methods that are consistent with the present invention. To this end, server 12 is linked via a computer network represented by lines in FIG. 1 to each of scheduling interface 14, program database 15, recall database 16, schedule database 18, printer 21 and patient interface 22. The programs run by server 12 are stored in program database 15 and include, among others, scheduling software and recall software.

As the label implies scheduling software is run by server 12 to maintain schedules for physicians that work at the facility associated with system 10. To this end, the scheduling software keeps track of a calendar for each one of the facility physicians and allows a scheduler (i.e., a facility employee charged with maintaining the physician's schedules) to modify the schedule thereby adding appointments to the schedule and removing appointments from the schedule when appropriate.

Referring also to FIG. 2, an exemplary schedule window 24 that may be provided via interface 14 by server 12 running the scheduling software illustrates a 7-day schedule for one of the facility physicians, Dr. Peters. Exemplary window 24 identifies Dr. Peters at the top of the window and includes a table including seven columns and a plurality of rows. The first column is a time column which divides the time in a working day into one hour time slots including 7 AM, 8 AM, 9 AM, etc. Each of the second through sixth columns in the table is a working day of the week column while the seventh column is a weekend column corresponding to Saturday and Sunday. Thus, for instance, the second column in the table corresponds to Monday, the third column corresponds to Tuesday, etc. The Monday column includes a status designation for each time slot in the time column where the status designations indicate either “open” or “closed”. An open status designation indicates that the time slot is open for Dr. Peters and that an appointment may be scheduled in that time slot. A closed status designation indicates that Dr. Peters is not free to conduct an appointment during that time slot either because the doctor already has an appointment scheduled or because the doctor is not taking an appointment during that time. Similarly, status designations are provided in each of the other day columns (i.e., the third through seventh columns of the table) for each of the time slots in the first column of the table.

In addition to the doctor designation and the table described above, window 24 includes various interfacing or input tools that can be used by the scheduler to perform scheduling functions. To this end, a mouse controlled arrow or pointing cursor 26 (hereinafter “cursor”) is illustrated which can be used (i.e., moved over an icon to select while a controlling mouse is double clicked) to select one of the status designations in the table to either receive additional information about a closed time slot or to select one of the open time slots for scheduling an appointment. In addition, schedule scrolling arrows 27 and 29 are provided that allow the scheduler to scroll through other days, weeks and months of Dr. Peters' schedule. Other tools for scrolling through physician's schedules or for searching for specific information in physician schedules are contemplated and are not described here in the interest of simplifying this explanation. In addition to cursor 26 and scrolling arrows 27 and 29, a CREATE RECALL icon 25 is illustrated which can be selected via cursor 26 to manually create a recall procedure as described above and described in greater detail below.

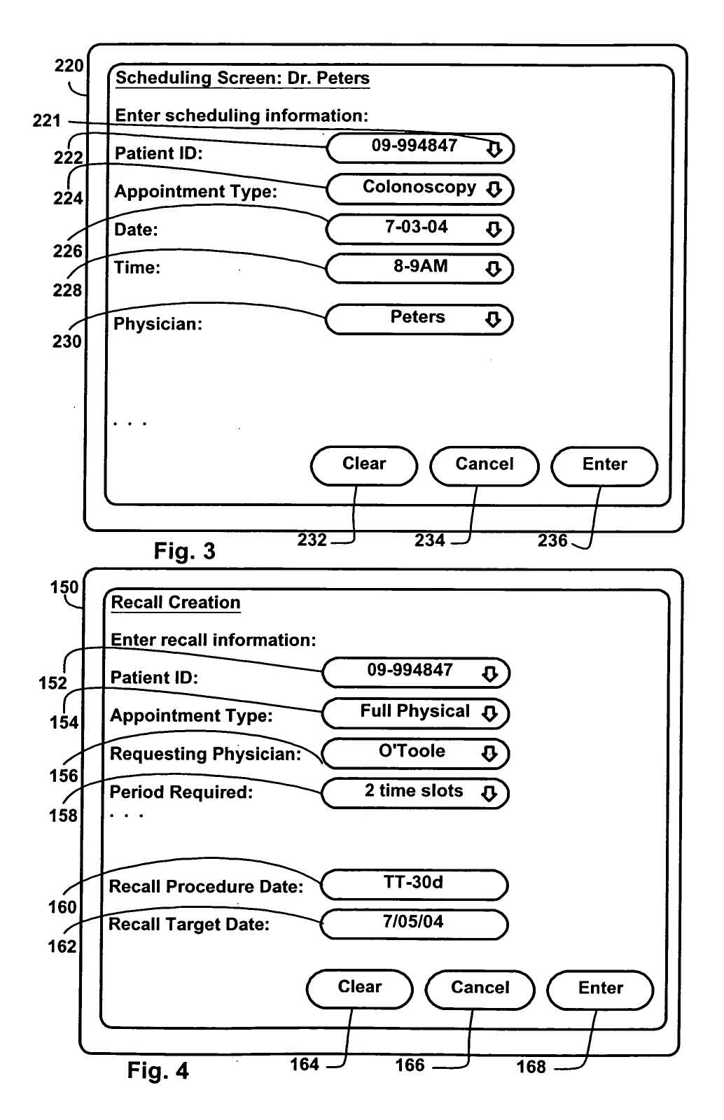

Referring still to FIG. 2, to schedule an appointment with Dr. Peters on Wednesday, July 3, in the 8 AM time slot, a scheduler uses cursor 26 to select the “open” status designation corresponding to the 8 AM time slot on Wednesday, July 3. When the “open” designation is selected, referring to FIG. 3, a scheduling window 220 is opened. The exemplary scheduling window 220 indicates at the top that the window corresponds to Dr. Peters and includes a plurality of appointment specifying fields that can be filled in by the scheduler to schedule an appointment for Dr. Peters. In this regard, the exemplary scheduling window 220 includes a patient ID field 222, an appointment type field 224, a date field 226, a time or time slot field 228 and a physician field 230. Here, information from the previous schedule window (see again FIG. 2) can be used to automatically populate at least some of the scheduling window fields. For example, because the scheduler selected the 8 AM time slot on Wednesday, July 3, the date and time fields 226 and 228, respectively, can automatically be filled in. In addition, physician field 230 can automatically be filled in as the scheduling screen window 220 corresponds to Dr. Peters. The scheduler fills in the remaining specifying fields with appointment specifying information. In the present example, the scheduler fills in the patient ID number 09-994847 in patient ID field 222 and a colonoscopy activity in appointment type field 224.

Here, it should be appreciated that much more appointment detail may be specified by a scheduler using the specifying fields illustrated and other specifying fields and that a simplified scheduling window has been described in the interest of simplifying this explanation. In addition, in at least some embodiments, pull-down menus may be provided for each of the specifying fields to help the scheduler correctly specify patient identifying numbers, appointment types, etc. In FIG. 3, arrows (one arrow labeled 221) are illustrated to indicate pull down menus for the specifying fields.

In addition to the physician designation and the specifying fields, cursor selectable CLEAR, CANCEL and ENTER icons 232, 234 and 236, respectively, are provided near the bottom of window 220. CLEAR icon 232 can be used to clear all of the information in the specifying fields above. CANCEL icon 234 can be used to cancel the current scheduling activity and return to the previous schedule window (e.g., see again FIG. 2). ENTER icon 236 is selectable to schedule an appointment consistent with the information specified in the fields of window 220.

Referring again to FIG. 1, the recall software, as its label implies, is run by server 12 to schedule recall procedures and to generate recall notices pursuant to the scheduled recall procedures that are sent to patients reminding the patients that appointments are to be scheduled in the near future. Here, in at least some cases, when a recall notice is generated, server 12 prints a hardcopy of the notice via printer 21 which is then mailed via regular mail to the patient. In other cases, where patient interfaces 22 are linked via an electronic computer network to server 12, server 12 may be programmed to automatically transmit e-mail messages or the like to a patient with the notice information. Similarly, where patients have network based accounts with the St. Mary's medical facility, notices may be posted on the patient accounts electronically via interface 22. Other ways of notifying patients of recall appointments are contemplated including transmission of facsimiles, pager messages, telephonic voice recordings, etc.

Referring once again to FIG. 2, when CREATE RECALL icon 25 is selected, a recall creation window is opened to facilitate creation of a new recall procedure. Referring also to FIG. 4, an exemplary recall creation window 150 is illustrated which has a format similar to the format of the scheduling window of FIG. 3. In this regard, recall creation window 150 includes several specifying fields that can be filled in by a scheduler to create a new recall procedure. The specifying fields include a patient ID field 152, an appointment type field 154, a requesting physician field 156, a period required field 158, a recall procedure date field 160 and a recall target date field 162. Patient ID field 152, as the label implies, is for entering a patient ID number. In the example, patient ID number 09-994847 is entered in field 152. Appointment type field 154 is used to specify the type of appointment that is associated with the recall procedure being created. In the example, the appointment type is a full physical type of appointment. The requesting physician field 156 is used to specify which facility physician requested the recall procedure. The period required field 158 is used to indicate the number of time slots needed to complete the appointment associated with the new recall procedure. Recall procedure date field 160 is used to specify the date on which the recall procedure should be performed (i.e., the date on which the recall notice should be mailed or transmitted). In the illustrated example, the recall procedure date is specified as “TD-30d” which means the target date minus thirty days. Thus, where the target date is Jul. 5, 2004, the recall procedure date would be thirty days prior to the target date and therefore would be Jun. 5, 2004. The recall target date field 162 is used to specify the target date for a recall appointment and, in the present example, is specified as Jul. 5, 2004.

As the label implies, a target date is simply a date that approximates the time at which a recall appointment should be scheduled. For instance, where the target date is Jul. 5, 2004, it may be suitable or appropriate for the recall appointment to be scheduled within a target range of five days prior to five days after the target date (i.e., June 30-July 10). The duration of the target range may vary as a function of the type of appointment being schedule, the time between the date on which a recall procedure is performed and the target date and other factors.

Referring still to FIG. 4, in addition to the specifying fields described above, recall creation window 150 includes CLEAR, CANCEL and ENTER cursor selectable icons 164, 166 and 168, respectively. CLEAR icon 164 is used to clear the information in the specifying fields above. CANCEL icon 166 is used to cancel the recall creation activity and to return to the previous window (see again FIG. 4). ENTER icon 168 is used to submit recall procedure specifying information to server 12 to store a new recall procedure that is consistent with the specified information and that is to be subsequently performed.

Referring once again to FIG. 1, in addition to the schedule and recall software, program database 15 may, in at least some embodiments, include a recall engine which automatically creates recall procedures to be performed to generate recall notices. To this end, it is contemplated that a general rule set can be defined for examining a patient database and identifying specific sets of circumstances or client/patient characteristics (i.e., age, sex, previous procedures, extended family history, genetics, etc.) that warrant appointments. For example, it may be that for each male patient over 60 years of age, it is recommended that the patient have a colonoscopy performed each year to identify early stages of cancerous activity that, if not identified quickly, could lead to premature death. In this case, the recall engine would cause server 12 to search the patient database for all male patients over 60 years of age and would automatically create recall procedures for identified patients on an annual basis. Many other sets of circumstances would be examined by the server 12 running the recall engine resulting in automatic scheduling of many different recall procedures.

Referring yet again to FIG. 1, when the schedule software in database 15 is used to examine or modify physician schedules, server 12 accesses schedule database 18 to obtain schedule information and provides window views via interface 14 to the scheduler. When the schedule is modified, server 12 updates database 18 to reflect modifications. Similarly, when recall procedures are manually created via interface 14, server 12 alters the recall database 16 to reflect the modifications.

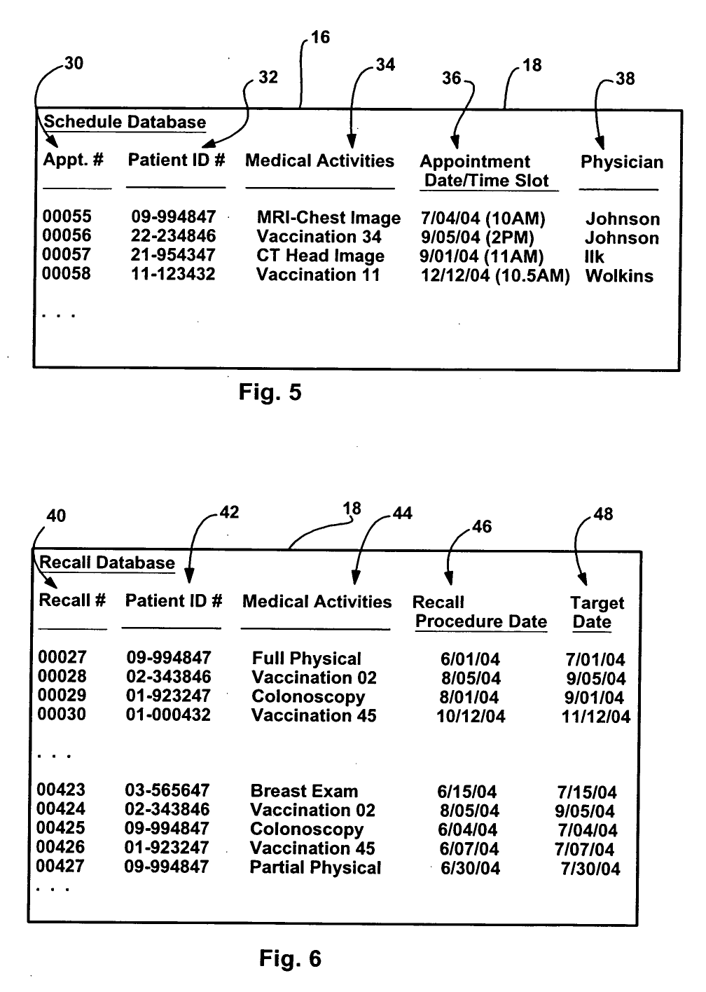

Referring now to FIG. 5, an exemplary schedule database 18 is illustrated that includes five correlated columns of information. The columns include an appointment number column 30, a patient ID number column 32, a medical activities column 34, an appointment date/time slot column 36 and a physician column 38. Appointment number column 30, as the label implies, includes a list of appointment numbers. Patient ID number column 32 lists a patient ID for each one of the appointment numbers in column 30. For example, patient ID number 09-994847 is associated with appointment number 00055, patient ID number 22-234846 is associated with appointment number 00056, and so on. Medical activities column 34 lists at least one and, in some cases may list several, activities that are to be performed during a scheduled appointment, where activities are listed for each one of the appointment numbers and patient ID numbers in columns 30 and 32. For example, a magnetic resonance (MRI) chest imaging procedure is listed in column 34 corresponding to appointment number 00055 in column 30. While only simplified medical activities are listed in the exemplary database 18, it should be appreciated that far more complex activities may be listed.

Appointment date/time slot column 36 lists a separate date and time slot for each one of the appointments in column 30. For example, appointment number 00055 in column 30 is associated with the date Jul. 4, 2004 and the 10 AM time slot. Physician column 38 identifies which facility physician is scheduled to attend an associated appointment in column 30. For example, Dr. Peters is scheduled to attend appointment number 00055 in column 30.

Referring now to FIG. 6, an exemplary recall database 16 is illustrated which includes five columns of correlated information that define all of the scheduled recall procedures for an associated facility. The database 16 columns include a recall number column 40, a patient ID number column 42, a medical activities column 44, a recall procedure date column 46 and a target date column 48. Recall number column 40 lists a separate and distinct recall number for each of the scheduled recall procedures. Exemplary recall numbers include number 00027, number 00028, etc.

Patient ID number column 42 lists a separate patient ID number for each one of the recall numbers in column 40. For example, patient ID number 09-994847 is associated with recall number 00027 in column 40. Patient ID numbers in column 42 may be associated with more than one recall number in column 40. For example, patient ID number 09-994847 is associated with each of recall numbers 00027, 00425 and 00427 in column 40 which means that there are at least three outstanding recall procedures already scheduled for the patient associated with ID number 09-994847.

Medical activities column 44, like the medical activities column 34 in database 18, lists at least one and, in most cases, a plurality of medical activities associated with each one of the recall numbers in column 40. For example, a “full physical” activity is associated with recall number 00027 in column 40 while a colonoscopy is listed as the activity in column 44 for the recall number 00425 in column 40.

Recall procedure date column 46 lists a separate date for each one of the recall numbers in column 40 on which the associated recall procedure is to be performed. Here, performance of a recall procedure means that server 12 (see again FIG. 1) runs the procedure to generate a notice for the patient associated with the patient ID number in column 42 reminding the patient that a follow-up appointment has to be scheduled some time in the near future (e.g., some time around an associated target date).

Target date column 48 indicates the target date for the recall appointment to be scheduled. In the example here it is assumed that the target date is always four weeks after the recall procedure date. Thus, the target date in column 48 for recall number 00027 is Jul. 1, 2004, thirty days after the recall procedure date of Jun. 1, 2004 in column 46.

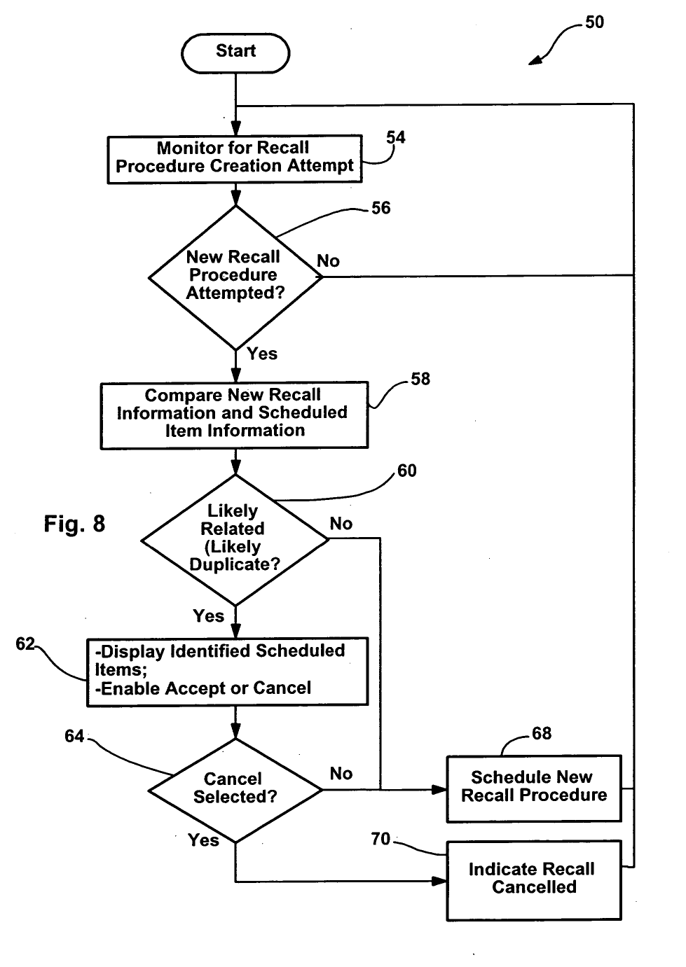

Hereinafter, various methods that are consistent with various aspects of the present invention are described in the context of the system described above. To this end, referring first to FIG. 8, an exemplary method 50 for identifying manually specified recall procedures that may be duplicative of previously scheduled recall procedures or of existing scheduled appointments is illustrated. Here, it is assumed that schedule and recall databases like those illustrated in FIGS. 5 and 6 already exist.

Referring to FIGS. 1 and 8, beginning at block 54, server 12 monitors scheduling interface 14 for an indication that the scheduler wants to create a new recall procedure. Here, in at least some embodiments, referring again to FIG. 4, creation of a new recall procedure is attempted when the recall specifying fields are populated and icon 168 is selected. At decision block 56, prior to enter icon 168 being selected, control loops back up to block 54. Once enter icon 168 is selected, control passes from decision block 56 to block 58.

At block 58, server 12 accesses the recall database 16 (see FIG. 6) and the schedule database 18 (see FIG. 5) and compares the new recall information with the scheduled appointment information and the scheduled recall information as specified in databases 18 and 16, respectively. Here, the phrase “scheduled item” is used to refer to any scheduled appointment or client matter as well as to any scheduled recall procedure.

The comparison at block 58 may take any of several different forms and may be cursory or very detailed, depending upon designer preference. For example, the comparison at block 58 may simply look for other scheduled items corresponding to a patient ID number that matches the ID number specified via the recall creation window 150 (see again FIG. 4). As another example, in addition to comparing patient ID numbers, the comparison may look for scheduled items having appointment dates (in the case of scheduled appointments) or target dates (in the case of scheduled recall procedures) that are within a predefined time period (e.g., two weeks, four weeks, that have overlapping target ranges, etc.) of the target date for the newly specified recall procedure. As still one other example, the comparison may compare patient ID numbers, times and medical activities to identify possibly association between the new recall information and the scheduled item information.

The purpose of the comparison at block 58 is to identify already scheduled items that may be duplicative with the newly specified recall procedure that the scheduler is attempting to create. In this regard, what constitutes a possible duplicative relationship can have different thresholds and is generally considered a matter of designer choice. For instance, if information specified for a new recall procedure is identical to information associated with a previously scheduled recall procedure except that the target dates are six weeks apart, server 12 may be programmed to not identify the scheduled procedure as possibly duplicative whereas if the target dates are two weeks apart the scheduled procedure may be flagged as possibly duplicative. Many different “thresholding rules” for identifying possibly related or duplicative scheduled items are contemplated and would be codified in the recall software stored in database 15.

Hereinafter, in the context of FIG. 8, the term “related” will be used to refer to scheduled recall procedures and/or appointments associated with information that is similar enough to information associated with a recall procedure newly specified to meet the system thresholding rules that signify possible duplicity.

Referring still to FIGS. 1 and 8, at decision block 60 where the newly specified recall procedure is not possibly related to any of the previously scheduled recall procedures or appointments, control passes to block 68. However, where the newly specified recall procedure is possibly related to at least one of the previously scheduled recall procedures or appointments, control passes from block 60 to block 62.

At block 62, server 12 displays the identified scheduled items via interface 14 and provides input tools that allow the scheduler to cancel the newly specified recall procedure or to accept and schedule the newly specified recall procedure. For example, referring once again to FIG. 4, assume that the information illustrated in the specifying fields has been entered and that enter icon 168 has been selected in an attempt to create a new recall procedure. In addition, referring again to FIGS. 5 and 6, assume that the schedule database 18 and recall database 16 include at least the scheduled items illustrated. In this example, the thresholding rules may cause server 12 to identify recall number 00027 in recall database 16 as a scheduled recall procedure that may be a duplication of the newly specified recall procedure. In this regard, the patient ID number (i.e., 09-994847) and medical activities (i.e., full physical) of the recall procedure associated with recall number 00027 and the newly specified recall procedure are identical. In addition, the recall target dates for scheduled recall number 00027 and the newly specified recall procedure are similar (i.e., the target dates are only four days apart). In this case, at block 62 in FIG. 8, server 12 may be programmed to provide a warning window warning the scheduler of a possible recall duplication.

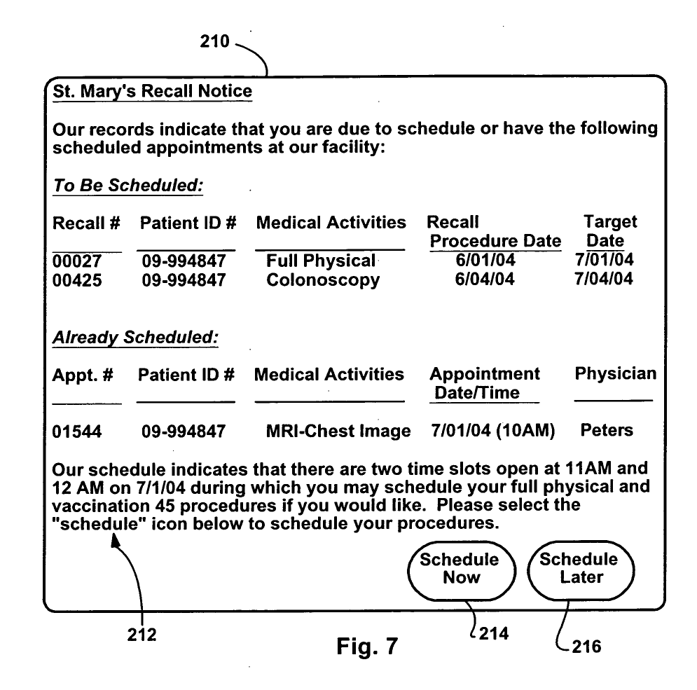

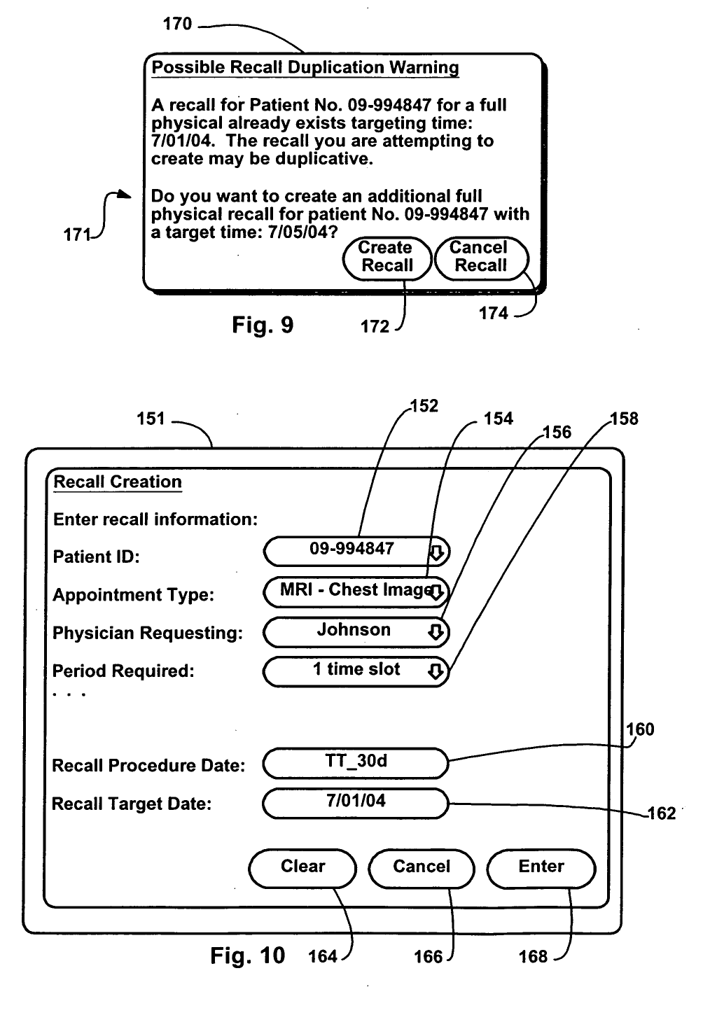

Referring now to FIG. 9, an exemplary warning window 170 is illustrated which, as shown, indicates that a recall for the patient associated with ID number 09-994847 already exists for a full physical and has a target date of Jan. 1, 2004. Warning window 170 includes a query 171 asking the scheduler whether or not the scheduler wants to create an additional full physical recall as specified via the recall creation window 150 (see again FIG. 7). In addition to the warning and the query, window 170 includes cursor selectable CREATE RECALL and CANCEL RECALL icons 172 and 174, respectively. To create an additional full physical recall procedure, the scheduler selects icon 172. To indicate that the newly specified recall procedure should not be created, the scheduler selects icon 174.

Referring still to FIGS. 1, 8 and 9, at decision block 64, where the scheduler indicates that the newly specified recall procedure is not related to the displayed item(s) by selecting icon 172, control passes to block 68 where server 12 schedules the new recall procedure after which control passes back up to block 54. If, however, the scheduler selects icon 174 thereby indicating that the newly specified recall procedure should be canceled, control passes to decision block 70. At block 70, server 12 indicates that the newly specified recall procedure has been canceled and then control passes to block 54.

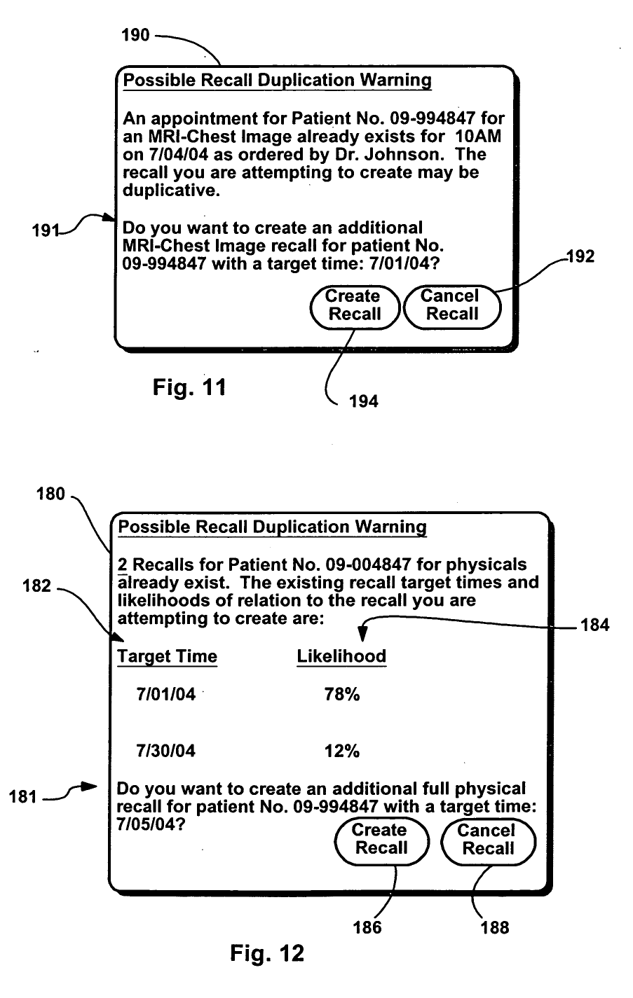

Referring again to FIGS. 1 and 8, in addition to identifying possible related scheduled recall procedures when a scheduler specifies a new recall procedure to be created, server 12 may identify a possible related scheduled appointment. In this regard, referring to FIG. 10, a screen creation window 151 similar to window 150 in FIG. 4 is illustrated where fields 152, 154, 156, 158, 160 and 162 are populated in a fashion that specifies an attempted recall procedure that is different than the recall procedure specified via window 150 in FIG. 3. Most importantly, the appointment type in field 154 in window 151 is for a MRI-chest image procedure as opposed to a full physical. When enter icon 168 is selected to attempt to create a new recall procedure corresponding to the information specified via window 151, referring also to FIG. 5, the thresholding rules may cause server 12 to identify appointment number 00055 at block 60. Here, at block 62, a recall warning window may be displayed similar to window 190 illustrated in FIG. 11. Window 190 indicates that an appointment already exists for a MRI-chest image procedure and provides information about the already scheduled appointment. Warning window 190 also queries (see 191) the scheduler to determine whether or not an additional recall procedure should be scheduled as specified via window 151 in light of the already scheduled and possibly related appointment. Cursor selectable CREATE RECALL and CANCEL RECALL icons 194 and 192, respectively, are provided near the bottom warning window 190 which are selectable to respond to the query. Where the scheduler selects icon 192, control passes from block 64 to block 70 where server 12 indicates that the recall has been canceled. If, at block 64, the scheduler selects icon 194 to create the newly specified recall procedure, at block 68 server 12 schedules the newly specified recall. After blocks 68 and 70 control passes back up to block 54.

Referring once again to FIG. 9, it is contemplated that in at least some cases server 12, upon comparing new recall information to schedule item information at block 58, will identify two or more scheduled items that may be related to the newly specified recall procedure being created. Here, where two or more items are identified, at block 62, in at least some cases, each of the identified items are displayed via scheduling interface 14.

Where two or more scheduled items are identified at blocks 58 and 60, in at least some embodiments, it is contemplated that server 12 may be programmed to compare the newly specified recall information associated with the recall procedure being created with the scheduled item information to identify some measure of probability that the newly specified recall procedure is related to each of the identified scheduled items. For example, referring again to FIGS. 4 and 6, in addition to identifying the recall procedure associated with recall number 00027 at blocks 58 and 60 in FIG. 8, the thresholding rules may cause server 12 to also identify the scheduled recall procedure associated with recall number 00427 as possibly related to the newly specified recall procedure as there are similarities between the information specified via window 150 and the information associated with recall number 00427. While the information associated with recall number 00427 is similar to the newly specified recall procedure information, the information associated with recall number 00427 is less similar than the information associated with recall number 00027. Thus, it is more likely that the recall procedure associated with recall number 00027 is related to the newly specified recall procedure than is the recall procedure associated with recall number 00427. How the comparison by server 12 is carried out and the importance of each of the information types (i.e., weightings applied to different information types) to the comparison is a matter of designer choice.

Referring now to FIG. 12, an exemplary recall warning window including percentage probabilities of association with the exemplary newly specified recall procedure as described above is illustrated. Consistent with the example above, warning window 180 indicates that two recall procedures already exist that may be related to the newly specified recall procedure and provides information regarding each of the already scheduled recall procedures. In addition to other information, the information about the scheduled recall procedures indicates their target dates 182 and the percentage probabilities 184 associated therewith. A query is provided near the bottom of warning window 180 requesting that the scheduler identify whether or not, in view of the identified and previously scheduled recall procedures, the newly specified recall procedure should be scheduled. CREATE RECALL and CANCEL RECALL icons 186 and 188, respectively, are provided near the bottom of warning window 180. When icon 186 is selected, a new recall procedure is scheduled. When icon 188 is selected, the newly specified recall procedure is canceled.

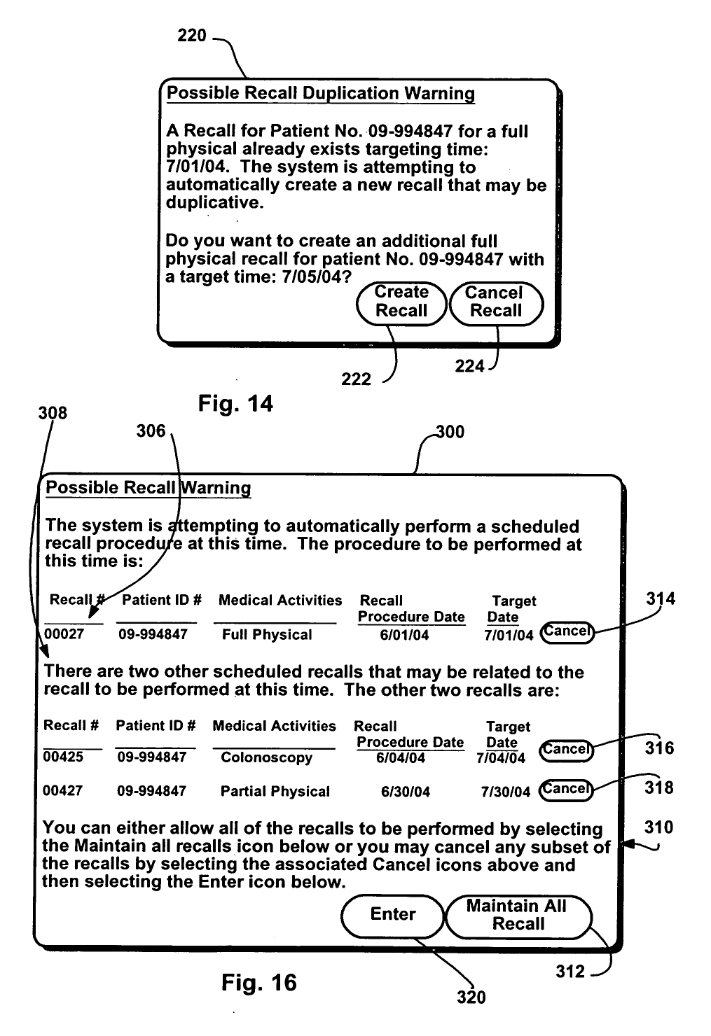

Consistent with the description above and in at least some cases, server 12 will run the recall engine stored in program database 15 to automatically create and schedule new recall procedures. Where new recall procedures are automatically scheduled by server 12, it is contemplated that, in at least some embodiments, a method similar to that described above with respect to FIG. 8 will be performed to identify and flag scheduled recall procedures and scheduled appointments that are possibly related to the newly created or attempted recall procedures. In this regard, referring once again to FIG. 8, blocks 54 and 56 may be used to monitor automatically generated new recall procedures and, when information associated with an attempted new recall procedure is similar to already scheduled item information, at block 62, a recall warning window may again be provided. Referring to FIG. 14, an exemplary warning window 220 is illustrated which includes a warning that the system is attempting to automatically schedule a new recall procedure that may be duplicative with at least one scheduled recall procedure or appointment and includes information about a scheduled recall procedure and the recall procedure that the system is automatically attempting to create. CREATE RECALL and CANCEL RECALL icons 222 and 224, respectively, are provided near the bottom of warning window 220 which can be selected to schedule or cancel the automatically generated recall procedure, respectively. A similar warning window is contemplated when server 12 determines that a new recall procedure being attempted by the system is possibly duplicative of an existing and scheduled patient matter or appointment.

While the invention is described above as one wherein new/possible/attempted recall procedures are compared to scheduled appointments and scheduled recall procedures as the new/possible/attempted recall procedures are created, it should be appreciated that, in at least some embodiments, comparison of attempted recall procedure information to schedule item information will be performed at other than the times at which the attempted recall procedures are specified. For example, in at least some cases, instead of performing a comparison when a recall procedure is created or specified, all recall procedures may initially be created and scheduled and the comparison may only occur later when a recall procedure is actually performed to generate a notice. As another example, whenever scheduling of a recall procedure is manually or automatically attempted, the procedure may be scheduled and comparison of all scheduled items may occur in batch at some subsequent time. For instance, at 2 AM every morning when server 12 is typically unburdened with other scheduling tasks, server 12 may perform a comparison process to identify possibly duplicative scheduled recall procedures and scheduled appointments. In this case, any possibly related procedures and/or scheduled appointments may be identified and placed in a queue for consideration by a scheduler when interface 14 (see again FIG. 1) is next activated.

When the scheduler next activates interface 14 (e.g., at the beginning of an 8 AM shift), server 12 may automatically present recall warnings one at a time via interface 14 in a manner similar to the warning illustrated in FIG. 14. In the alternative, although not illustrated, a recall warning table may be generated to organize warnings for consideration by the scheduler.

In a particularly advantageous case, manually attempted recall procedures are compared to scheduled items as procedure scheduling is attempted while automatically generated recall procedures are compared to scheduled items in batch or at least presented to the scheduler for consideration in batch. Here, by considering possibly related scheduled items as procedures are manually specified, the scheduler will already have a context (i.e., the attempted scheduling of a recall procedure) in which to consider the results of the comparison. By considering possibly related scheduled items in batch that are automatically identified, the scheduler's normal scheduling routines will not be interrupted intermittently throughout the day.

In at least some embodiments of the present invention it is contemplated that, when more than one scheduled item is identified during a comparison with information associated with a specific recall procedure, server 12 may allow the scheduler to allow or maintain any subset of the specific procedure and the identified scheduled items or indeed to cancel all of the items. Thus, for instance, where two recall procedures are scheduled and are possibly related, this concept allows a scheduler to remove either one of the two scheduled recall procedure from the schedule or to cancel both of the recall procedures. Similarly, where a recall procedure is scheduled and a related appointment is scheduled, this procedure allows the scheduler to remove either the recall procedure or the possibly related scheduled appointment from the schedule or to cancel both.

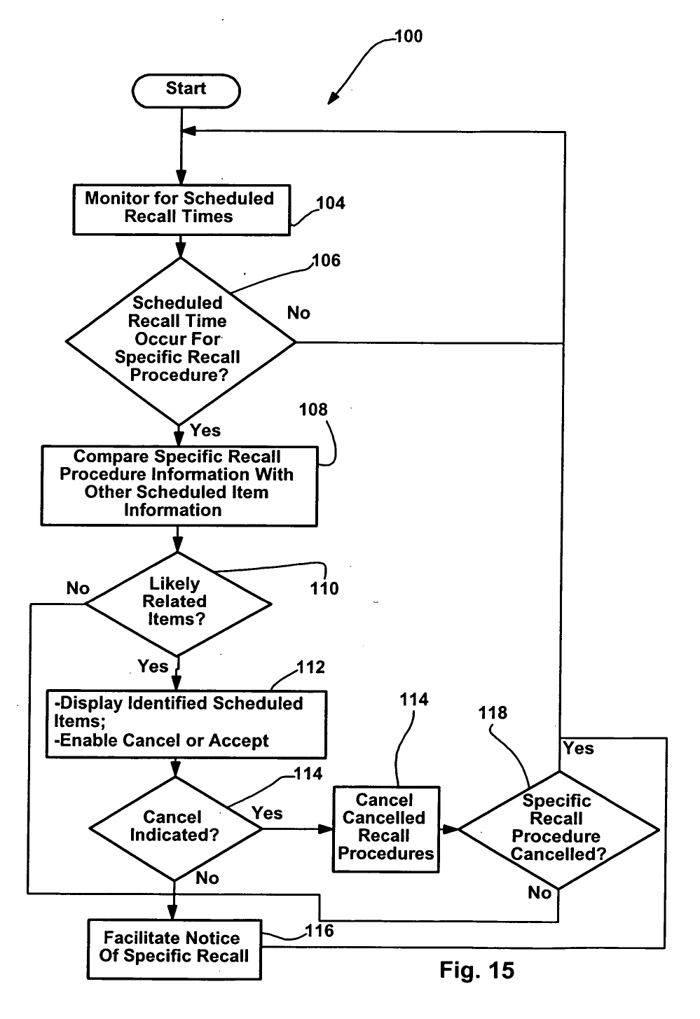

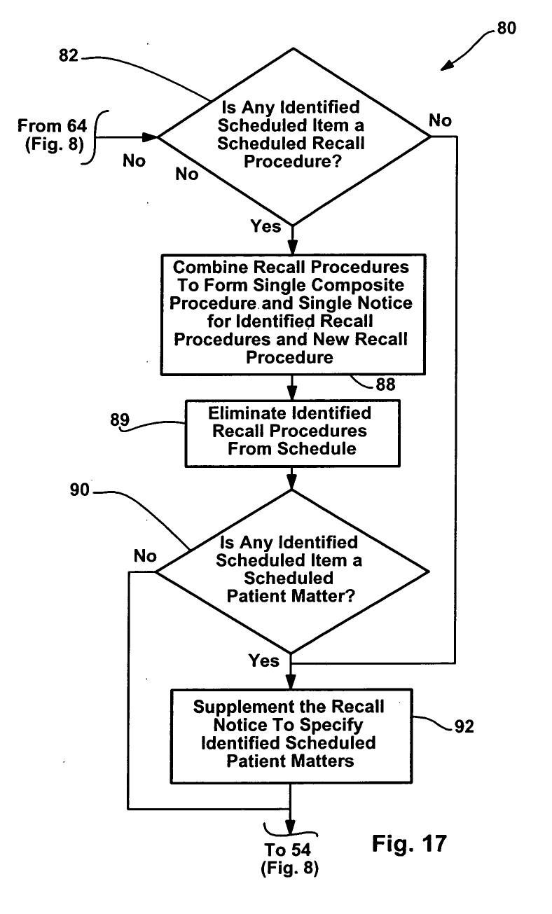

Referring now to FIG. 15, a method 100 that identifies duplicative scheduled items when recall procedures are to be performed and that allows a scheduler to select any subset of the related scheduled items to be performed or to remain scheduled is illustrated. Here, it is assumed that all manually or automatically attempted scheduling of recall procedures initially result in scheduled procedures even if possibly related items are already scheduled.

Referring to FIGS. 1 and 15, at block 104, server 12 monitors the scheduled recall procedures to identify when a recall time occurs (i.e., when a recall procedure is to be performed to generate a notice). At block 106, when none of the recall times is the current time, control loops from decision block 106 back up to block 104. Once one of the scheduled recall times for a specific recall procedure occurs, control passes from decision block 106 down to block 108.

At block 108, server 12 compares the specific recall procedure information with scheduled item information for the other scheduled items (e.g., for at least a subset of the other scheduled recall procedures and the scheduled appointments). At block 110, where the specific recall procedure is not likely related to any of the other scheduled items, control passes to block 116 where the specific recall procedure is performed to generate a suitable hard copy or electronic recall notice. However, at block 110, when the specific recall procedure is possibly related to one of the other scheduled items (i.e., is possibly related to one of the other scheduled recall procedures or one of the scheduled appointments), control passes down to block 112. At block 112, server 12 displays the identified scheduled items via interface 14 and enables cancellation of one or more of the specific recall procedures and the other displayed scheduled items.

In this regard, FIG. 16 illustrates a recall warning window 300 that identifies a specific recall procedure (#00027) that server 12 is currently to be performed as well as two other possibly related recall procedures (# 00425 and # 00427). In addition, window 300 provides an explanation 308 that describes the possible relationship between the procedure to be currently performed and the other two recall procedures along with instructions 310 for selecting a subset of the procedures to cancel or for maintaining all of the displayed procedures. In this case, to maintain all of the procedures a MAINTAIN ALL RECALLS icon 312 is selectable. To cancel any subset of the displayed procedures, a subset of CANCEL icons 314, 316 and 318 may be selected followed by ENTER icon 320. Thus, for instance, after considering the information presented via window 300, a scheduler may decide that recall #00427 is duplicative with recall #00027 and should be canceled. To cancel recall #00427, the scheduler selects CANCEL icon 318 and then selects ENTER icon 320.

Referring again to FIG. 15, at block 114, if the scheduler indicates that at least one of the displayed procedures is to be canceled, server 12 cancels the selected procedure from the schedule. At block 118, if the specific recall procedure (i.e., the procedure that is to be performed at the current time) was canceled, control passes back up to block 104 without performing the specific procedure. If the specific procedure was not canceled, control passes to block 116 where the specific procedure is performed. At block 114, if none of the displayed procedures are canceled, control passes to block 116 where the specific procedure is performed.

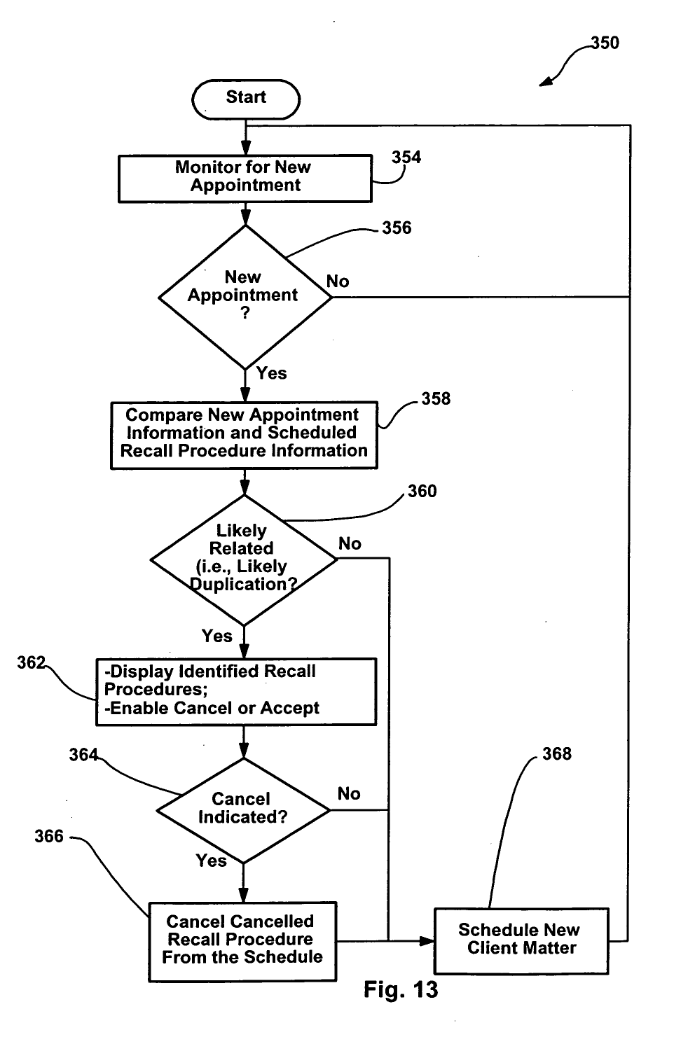

In addition to searching the scheduled database and the recall database to identify scheduled appointments and scheduled recall procedures that may be related to recall procedures being created or that are about to be performed, the invention also contemplates that server 12 may be programmed to compare new appointments as those appointments are being created or scheduled to scheduled recall procedures so that the scheduled recall procedures can be removed from the schedule if they are related (i.e., are duplicative) to the newly created appointments. To this end, an exemplary method 350 is illustrated in FIG. 13. Referring also to FIG. 1, at block 354, server 12 monitors interface 14 for entry of a new appointment via window 220 illustrated in FIG. 5. In FIG. 3, a new appointment is indicated by selection of enter icon 236. At decision block 356, if no new appointment has been indicated, control passes back up to block 354. Once a new appointment is indicated at block 356, control passes to block 358 where server 12 compares the new appointment information and the information corresponding to each of the scheduled recall procedures in recall database 16. At decision block 360, server 12 determines whether or not the new appointment is possibly related to any of the scheduled recall procedures. Where the new appointment is not likely related to one of the scheduled recall procedures, control passes to block 368 where server 12 schedules the new client matter after which control passes back up to block 354.

At block 360, where the new appointment is possibly related to one of the scheduled recall procedures, control passes to block 362 where server 12 displays the identified recall procedures via interface 14 and enables cancellation or maintenance of the identified recall procedures. At block 364, where the scheduler indicates that all of the identified recall procedures should be maintained (e.g., via selection of a MAINTAIN RECALL icon or the like), control passes to block 368. If, however, at decision block 364, the scheduler indicates that a subset of the identified recall procedures should be canceled (e.g., via a window similar to the window illustrated in FIG. 16), control passes to block 366 where the canceled procedures are removed from the schedule. After block 366, control passes to block 368.

According to another aspect of the present invention, it is contemplated that server 12 may analyze scheduled recall procedures and appointments and, where appropriate, combine recall procedures so that, instead of sending out multiple notices for multiple appointments to be scheduled, a smaller number of notices may be sent out so that patients receiving the notices have more information when they attempt to schedule appointments in an efficient manner. In addition, it is contemplated that server 12 may, when a notice is sent to a patient, indicate existing scheduled appointments so that, if possible, the patient can attempt to schedule other appointments temporally proximate the already scheduled appointments. In this regard, referring to FIG. 17, a sub-method 80 which may be substituted for block 68 in FIG. 8 is illustrated.

Here, referring to FIG. 8, it will be assumed that the comparison that occurs at block 58 will be heavily weighted toward similarities between recall procedure target dates and scheduled appointment times so that scheduled items that have target dates or times that are similar to a recall target date are identified as possibly related. For instance, irrespective of similarities between other information, if compared target dates and scheduled times are within two weeks of each other for scheduled items or an attempted recall procedure for a single patient, each of those items and procedures would be identified as possibly related in at least one example. Thus, the phrase “possibly related” here has broader meaning than “possibly duplicative” and covers all temporally proximate events for a specific client/patient.

It will also be assumed here that subprocess 80 is performed as recall procedures are manually created or attempted. Nevertheless, it should be recognized that subprocess 80 could be performed during automatic recall procedure generation or during a periodic batch processing.

Referring to FIGS. 1, 8 and 17, if the newly specified recall procedure is not cancelled at block 64, control passes to block 82. At decision block 82, server 12 determines whether or not any identified scheduled item is a scheduled recall procedure. Where none of the identified scheduled items is a scheduled recall procedure, control passes to block 92. Where at least one of the identified scheduled items is a scheduled recall procedure, control passes to block 88 where the identified scheduled recall procedures are combined with the newly specified recall procedure to form a single composite recall procedure that will generate a single notice for all of the recall procedures having temporally proximate target dates. At block 89, server 12 eliminates all of the identified scheduled recall procedures from the schedule other than the composite recall procedure.

At block 90, server 12 determines whether or not any identified scheduled item is a scheduled patient matter. Where none of the scheduled items are patient matters, control passes back to block 54 in FIG. 8. At block 90, however, if at least one of the identified scheduled items is a scheduled patient matter, control passes to block 92. At block 92, server 12 supplements the recall notice associated with the remaining recall procedure to specify the identified scheduled patient matters after which control passes to block 54 in FIG. 8.

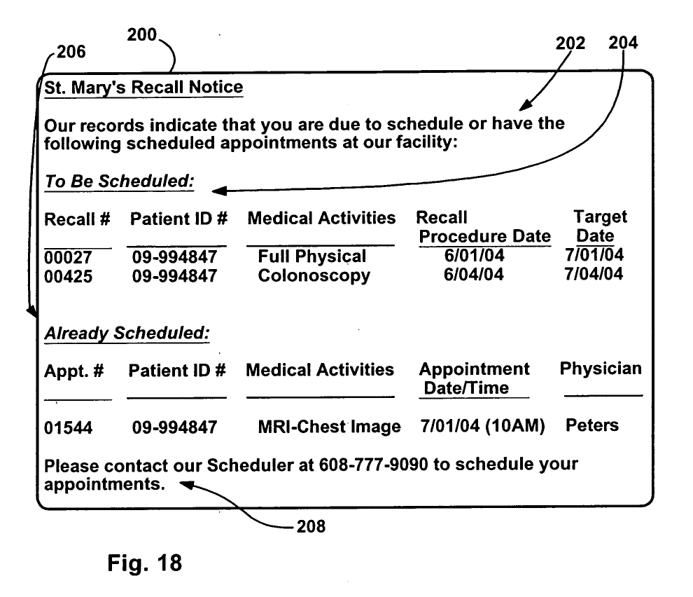

Referring now to FIG. 18, a composite electronic recall notice window 200 is illustrated which includes a notice 202 to a patient indicating that appointments need to be scheduled and, where appropriate, that appointments are already scheduled at the St. Mary's facility. Appointments to be scheduled are identified in a “To be Scheduled” section 204 of the notice while already scheduled appointments are identified in an “Already Scheduled” section 206 of the notice. Consistent with the information in the databases illustrated in FIGS. 5 and 6, the composite notice 200 indicates two appointments to be scheduled for the patient associated with ID number 09-994847 and one already scheduled appointment for the same patient. Information 208 regarding how to schedule appointments is also provided near the bottom of notice window 200.

In some embodiments, it is contemplated that, prior to an electronic recall notice being generated and transmitted to a patient, server 12 may be programmed to check physician schedules to identify suitable time slots that could be used to accommodate appointments associated with the notices. To this end, when a recall procedure time occurs targeting a date one month from the recall procedure time, server 12 may access physician schedules, identify the appropriate physician to facilitate medical activities associated with the recall appointment and then analyze the appropriate schedules to identify time slots that could accommodate the recall appointments. Once an appropriate schedule time slot has been identified, the recall notice may be supplemented to suggest the currently open time slot or slots to the patient. In addition, icons for electronically accepting or rejecting suggested time slots may be provided on the electronic notice whereby, if one of the icons is selected, either the appointment is scheduled in the suggested time slot or the time slot is foregone for the time being by the patient.

Similarly, where a composite recall notice (i.e., a notice including information corresponding to at least first and second different recall appointments or to at least one recall appointment and one already scheduled appointment) is to be generated by server 12, server 12 may search physician schedules to identify optimal sets of time slots, if they exist, for all of the scheduled appointments and recall appointments associated with the composite notice. Thus, for instance, where one appointment has already been scheduled and two other appointments need to be scheduled and are to be indicated via the recall notice, server 12 can, if possible, identify two time slots temporally proximate the time slot corresponding to the already scheduled appointment and suggest those time slots as appropriate or optimal for scheduling the other two appointments.

An exemplary recall notice window 210 that may be electronically provided to a patient and that indicates optimal scheduling time slots for the appointments to be scheduled is illustrated in FIG. 7. The notice regarding optimal time slots is identified by label 212. SCHEDULE NOW and SCHEDULE LATER icons 214 and 216, respectively, are provided wherein, if icon 214 is selected, the suggested optimal time slots are used to schedule the other two appointments and, if icon 216 is selected, the suggested time slots are foregone for the time being.

In at least some embodiments it is contemplated that, when an electronic recall notice is received by a patient or client, the notice may allow the client to indicate that the procedure or potential appointment associated with the notice has already been completed. Here, where a client indicates that a procedure has already been completed, when the indication is received by server 12, server 12 may be programmed to do any of several different things. First, server 12 may simply store the indication that the procedure has been completed and then delete the recall procedure from the recall data base 16.

Second, server 12 may be programmed to obtain information regarding completion of the procedure from the client such as, for instance, when the procedure was completed, who completed the procedure, where the procedure was completed, the results of the procedure if there were any, etc. Where additional information about a completed procedure is sought and provided, server 12 may store that information for subsequent purposes such as, for instance, purposes associated with a physician that ordered the procedure associated with the recall. Here, server 12 may provide the additional information to the physician that ordered the recall associated with the notice via an e-mail or the like or may simply archive that information for access by the physician.

Third, server 12 may be programmed to attempt to obtain a formal record of the completed procedure. In this regard, when a client indicates that a procedure has been completed, server 12 may request authorization from the client to obtain a formal record from the entity that carried out the procedure. Where the server 12 receives a formal record or receives information about a completed procedure from a client, server 12 may be programmed to compare the record or received information to the procedure associated with the original notice to independently determine whether or not the completed procedure meets the requirements of the recall procedure. Where the completed procedure meets the requirements of the recall procedure, server 12 may be programmed to confirm that the completed procedure met the requirements. In the alternative, where the completed procedure does not meet the requirements of the recall procedure, server 12 may be programmed to generate a new recall notice indicating that the recall procedure is still required.

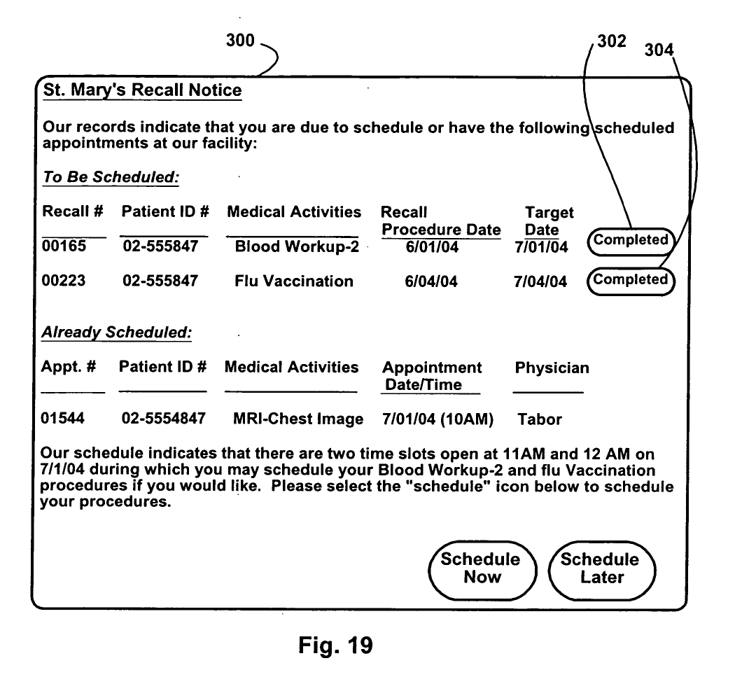

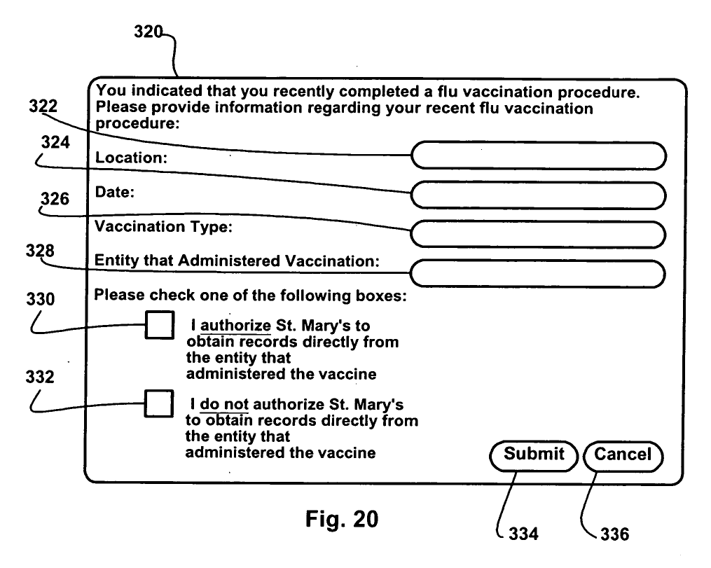

Referring now to FIG. 19, an exemplary recall notice window 300 similar to the window illustrated in FIG. 7 is provided where window 300 includes COMPLETED icons 302 and 304 for each one of the recall procedures to be scheduled. Here, when one of the recall procedures has been completed, the client can select an associated COMPLETED icon 302 or 304 to indicate that the procedure has been completed. In the present example, for instance, when icon 304 is selected to indicate that the flu vaccination associated with recall number 00223 has been completed, server 12 may provide window 320 illustrated in FIG. 20 to obtain additional information regarding the completed vaccination as well as to obtain authorization to seek a formal record from the entity that administered the vaccination. In this regard, a location field 322, a date field 324, a vaccination type field 326 and an entity field 328 are provided to textually entering information regarding the completed vaccination. In addition, alternative boxes 330 and 332 are provided for authorizing or withholding authorization for obtaining a formal confirmatory record from the entity that administered the vaccination. After information has been entered into fields 322, 324, 326 and 328 and after one of the boxes 330 or 332 has been selected via a mouse controlled icon or the like, the client can select SUBMIT icon 334 to submit the additional information to server 12. In the alternative, the client can select CANCEL icon 336 to return to the window illustrated in FIG. 19. Where the client authorizes formal record retrieval, the record may be automatically obtained and archived.

While the invention may be susceptible to various modifications and alternative forms, specific embodiments have been shown by way of example in the drawings and have been described in detail herein. However, it should be understood that the invention is not intended to be limited to the particular forms disclosed. For example, while both the recall duplicity identifying and notice combining concepts are described as being performed in a single method, it should be appreciated that each of those concepts could be implemented separately. In addition, while the inventions are described in the context of a medical facility, it should be appreciated that the concepts may also be applied in other industries and environments where notices of appointments, encounters, maintenance, procedures, etc., for various resources to be scheduled are generated.

Moreover, while possible related recall procedures and scheduled items are identified and presented to a scheduler for determining if any of the procedures or items should be cancelled in the above examples, in at least some cases it is contemplated that server 12 may automatically cancel certain highly probably duplicative recall procedures without presenting the cancel option to the scheduler.

Furthermore, while the embodiment described above where probabilities of relatedness are determined includes presenting identified items along with percentages, it should be appreciated that probabilities may be expressed in other formats. For instance, identified scheduled items may be arranged in an ordered list with the most probably related item at the top and the least probably related item at the bottom.

In addition, in some embodiments, recall procedures may only be compared to other scheduled recall procedures instead of also being compared to scheduled client/patient appointments to identify possibly related items.

Moreover, while the concepts described above are in the context of a system that generates recalls on a client by client basis, it should be appreciated that, in at least some cases, the server 12 may be programmed to streamline notice generation even more by generating notices that consider the schedules of, and appointments to be scheduled for, related persons/clients. In this regard, for instance, where a family includes a father, a mother and three children, server 12 may be programmed to, whenever a notice is to be generated for any person in the family, check scheduled items and items to be scheduled for every person in the family and to suggest scheduling times that may be optimal where two or more appointments have proximate target dates and/or times. Thus, for instance, if the mother is already scheduled for an appointment on Jun. 5, 2004 and a target date for a recall for one of the children is on Jun. 10, 2004, the system may generate a recall notice for the child that also indicates the mother's currently scheduled appointment time on Jun. 5, 2004 so that, if possible, optimal times can be scheduled for all of the related persons. Moreover, in the present example, if the mother's scheduled appointment is for 10:00 AM on Jun. 5, 2004 and a suitable schedule opening exists at 10:30 AM on Jun. 5, 2004, the recall may suggest the 10:30 AM time slot as a possible time for scheduling the child's appointment.

Thus, the invention is to cover all modifications, equivalents, and alternatives falling within the spirit and scope of the invention as defined by the following appended claims. To apprise the public of the scope of this invention, the following claims are made:

What is claimed is:

1. A method for use with a resource scheduling system that includes a schedule that at least one of associates resource time slots with scheduled client matters and associates scheduled recall procedures with schedule times, each scheduled recall procedure for generating at least one recall notice at a corresponding schedule time indicating a possible client matter to be scheduled, each of the scheduled client matters and scheduled recall procedures being a scheduled item, the schedule including scheduled item information associated with each of the scheduled items, the method for facilitating schedule management and comprising the steps of:
receiving recall information for a possible recall procedure that may be scheduled;
comparing the received recall information with at least a subset of the scheduled item information to identify at least one scheduled item that may be related to the possible recall procedure; and
performing at least a portion of a scheduling process as a function of the at least one identified scheduled item.

2. The method of claim 1 further including the step of providing an interface and wherein the step of performing a scheduling process includes indicating the at least one identified scheduled item via the interface.

3. The method of claim 2 wherein the step of providing an interface includes providing an input device enabling an interface user to indicate that the possible recall procedure is duplicative with the at least one identified scheduled item.

4. The method of claim 3 further including the step of receiving an indication that the possible recall procedure is duplicative with the at least one identified scheduled item.

5. The method of claim 4 further including the step of updating the schedule so that a single scheduled item is included in the schedule for the at least one scheduled item and the possible recall procedure.

6. The method of claim 5 wherein the step of updating the schedule includes, where the identified scheduled item is a scheduled client matter, one of replacing the scheduled client matter with a recall procedure in the schedule and maintaining the scheduled client matter in the schedule.

7. The method of claim 5 wherein the step of updating the schedule includes, where the identified scheduled item is a scheduled recall procedure, one of replacing the scheduled recall procedure with a recall procedure at a different schedule time, maintaining the scheduled recall procedure in the schedule and modifying the scheduled recall procedure.

8. The method of claim 1 wherein the step of comparing includes identifying a plurality of scheduled items where each identified scheduled item is associated with information that is similar to the received information and wherein the step of performing a scheduling process includes performing a scheduling process as a function of the plurality of identified scheduled items.

9. The method of claim 8 further including the step of providing an interface and wherein the step of performing a scheduling process includes displaying the identified scheduled items via the interface.

10. The method of claim 9 wherein the step of providing an interface includes providing an input device enabling an interface user to cancel at least one of the identified scheduled items and the possible recall procedure.

11. The method of claim 10 further including the steps of receiving an indication to cancel at least one of the identified scheduled items and the possible recall procedure and updating the schedule so that the cancelled one of the items and recall procedure is removed from the schedule.

12. The method of claim 8 further including the step of identifying probabilities that each of at least a subset of the identified scheduled items is related to the possible recall procedure and wherein the step of performing a scheduling process includes performing a scheduling process that is also a function of the probabilities.

13. The method of claim 12 further including the step of providing an interface and wherein the step of performing a scheduling process includes displaying at least the subset of the scheduled identified items that are most probably related via the interface.

14. The method of claim 12 further including the step of providing an interface and wherein the step of performing a scheduling process includes displaying at least a subset of the scheduled items in a manner that visually distinguishes each item in the subset as a function of associated probabilities.

15. The method of claim 14 wherein the step of displaying each item in the subset in a visually distinguishing manner includes expressing the probabilities in relative percentages.

16. The method of claim 12 wherein the probabilities are determined as a function of the comparison of the received information and the information associated with the scheduled items.

17. The method of claim 16 wherein the step of receiving recall information includes receiving a time associated with the possible recall procedure and wherein the probabilities are determined at least in part as a function of a comparison of the received time and at least one of the time slots associated with the scheduled client matters and the times associated with the scheduled recall procedures.

18. The method of claim 1 wherein the step of comparing includes identifying a single scheduled item and the step of performing a scheduling procedure includes associating the received information with the single scheduled item and automatically updating the schedule so that a single schedule item is included in the schedule for the identified scheduled item and the possible recall procedure pair.

19. The method of claim 1 further including the step of providing a scheduling interface, the step of receiving including receiving the recall information via the interface, the step of performing a scheduling process including, when a scheduled item is identified, presenting a query via the interface requesting an interface user to indicate if the possible recall procedure may be duplicative with the identified scheduled item.

20. The method of claim 18 wherein the scheduling process further includes receiving an indication via the interface, where the received indication indicates that the possible recall procedure is duplicative, allowing only one instance of the possible recall procedure and the scheduled item in the schedule and, where the received indication indicates that the possible recall procedure is other than duplicative, facilitating scheduling of the possible recall procedure in addition to the scheduled item.

21. The method of claim 20 wherein, when the identified scheduled item is a scheduled recall procedure, the step of facilitating scheduling of the possible recall procedure in addition to the scheduled item includes combining the possible recall procedure and the identified scheduled recall procedure so that a single notice is generated for both the identified and possible recall procedures.

22. The method of claim 21 wherein the step of combining includes generating a single notice that identifies both a possible client matter associated with the identified scheduled recall procedure and a possible client matter associated with the possible recall procedure.

23. The method of claim 20 wherein, when the identified scheduled item is a scheduled client matter, the step of facilitating scheduling of the possible recall procedure in addition to the scheduled item includes generating a single recall notice identifying the possible recall procedure and providing a reminder of the scheduled client matter.

24. The method of claim 20 wherein, when the identified scheduled item is a scheduled client matter, the step of facilitating scheduling of the possible recall procedure in addition to the scheduled item includes facilitating scheduling the possible recall procedure prior to the identified scheduled client matter.

25. The method of claim 24 wherein the step of facilitating scheduling of the possible recall procedure further includes suggesting in the notice associated with the possible recall procedure that the possible client matter associated with the notice may be scheduled temporally proximate the identified scheduled client matter.

26. The method of claim 1 wherein the step of receiving recall information includes providing a rule set for automatically generating recall notices as a function of client characteristics, comparing client information to the rule set and generating recall information as a function of the comparison.

27. The method of claim 26 wherein client characteristics include at least a subset of extended medical history, extended family history and genetic information.

28. The method of claim 26 wherein client characteristics periodically change and, when client characteristics change, in at least some cases the step of comparing includes generating new recall information as a function of the comparison.

29. The method of claim 1 wherein the step of receiving recall information includes receiving a schedule time for the possible recall procedure, the step of comparing the received recall information including identifying scheduled client matters and recall procedures having time slots and times, respectively, that are within a time period of the received schedule time.

30. The method of claim 29 wherein the step of performing a scheduling process includes combining the possible recall procedure with temporally proximate recall procedures.

31. The method of claim 30 wherein the step of performing a scheduling process also includes generating a recall notice that, in addition to indicating possible client matters for each of the recall procedures, also identifies at least one temporally proximate scheduled client matter.

32. The method of claim 29 further including providing an interface wherein the step of performing a scheduling process includes presenting at least a subset of the identified scheduled client matters and scheduled recall procedures via the interface.

33. The method of claim 1 wherein the step of performing at least a portion of a scheduling process includes providing a notice identifying the at least one identified item and wherein the notice is provided as one of an electronic message, a printed message and a voice message.

34. The method of claim 1 wherein the received information corresponds to a first client and the first client is related to at least a second client, the step of comparing the received recall information with at least a subset of the scheduled item information to identify at least one scheduled item that may be related to the possible recall procedure including comparing the received information to scheduled item information for each of the first and second clients.

35. The method of claim 2 wherein the step of providing an interface includes providing a network linked interface.

36. The method of claim 35 wherein the network linked interface is an internet linked interface.

37. A method for use with a resource scheduling system that includes a schedule that associates resource time slots with scheduled client matters and associates scheduled recall procedures with schedule times, each scheduled recall procedure for generating at least one recall notice for an associated possible client matter at a corresponding schedule time, the schedule including scheduled recall procedure information associated with each of the scheduled recall procedures, the method for facilitating schedule management and comprising the steps of:
receiving scheduling information for a client matter to be scheduled;
comparing the received scheduling information with at least a subset of the scheduled recall procedure information to identify at least one scheduled recall procedure that may be related to the client matter to be scheduled; and
performing a scheduling process as a function of the at least one identified scheduled recall procedure.

38. The method of claim 37 further including the step of providing an interface and wherein the step of performing a scheduling process includes indicating the at least one identified scheduled recall procedure via the interface.

39. The method of claim 38 wherein the step of providing an interface includes providing an input device enabling an interface user to indicate that the client matter to be scheduled is duplicative with the at least one identified recall procedure indicated via the interface.

40. The method of claim 39 further including the step of receiving an indication that the client matter to be scheduled is duplicative with the at least one identified recall procedure and updating the schedule so that a single scheduled item is included in the schedule for the client matter to be scheduled and the identified recall procedure.

41. The method of claim 37 wherein the step of comparing includes identifying a plurality of scheduled recall procedures where each identified recall procedure is associated with information that is similar to the received scheduling information and wherein the step of performing a scheduling process includes performing a scheduling process as a function of the plurality of identified recall procedures.

42. The method of claim 41 further including the step of providing an interface and wherein the step of performing a scheduling process includes displaying the identified recall procedures via the interface.

43. The method of claim 42 wherein the step of providing an interface includes providing an input device enabling an interface user to indicate that the client matter to be scheduled is duplicative of at least one of the identified recall procedures.

44. The method of claim 43 further including the step of receiving an indication via the input device that the client matter to be scheduled is duplicative of at least one of the identified recall procedures and updating the schedule so that a single scheduled item is included in the schedule for the client matter to be scheduled and the at least one of the identified recall procedures.

45. The method of claim 41 further including the step of identifying probabilities that each of at least a subset of the identified recall procedures will be related to the client matter to be scheduled and wherein the step of performing a scheduling process includes performing a scheduling process that is also a function of the probabilities.

46. The method of claim 45 further including the step of providing an interface and wherein the step of performing a scheduling process includes identifying at least the subset of the identified recall procedures that are most probably to be related to the client matter to be scheduled via the interface.

47. The method of claim 45 further including the step of providing an interface and wherein the step of performing a scheduling process includes presenting at least a subset of the identified recall procedures in a manner that visually distinguishes each of the procedures in the subset as a function of associated probabilities.

48. The method of claim 47 wherein the step of presenting the identified recall procedures in a visually distinguishing manner includes expressing the probabilities in relative percentages.

49. The method of claim 45 wherein the probabilities are determined as a function of the comparison of the received scheduling information and the information associated with the recall procedures.

50. The method of claim 49 wherein the step of receiving scheduling information includes receiving an indication of a schedule time for the client matter to be scheduled and wherein the probabilities are determined at least in part as a function of a comparison of the received time and the times associated with the scheduled recall procedures.

51. The method of claim 37 further including the step of providing a scheduling interface, the step of receiving including receiving the scheduling information via the interface, the step of performing a scheduling process including, when at least one scheduled recall procedure is identified, presenting a query via the interface requesting an interface user to indicate if the client matter to be scheduled may be duplicative with the identified scheduled recall procedure.

52. The method of claim 51 wherein the scheduling process further includes receiving an indication via the interface, where the received indication indicates that the client matter to be scheduled is duplicative with a specific scheduled recall procedure, allowing only one instance of the client matter to be scheduled and the identified recall procedure in the schedule and, where the received indication indicates that the client matter to be scheduled is other than duplicative, facilitating scheduling of the client matter to be scheduled in addition to the identified recall procedure.

53. The method of claim 38 wherein the step of providing an interface includes providing a network linked interface.

54. The method of claim 53 wherein the network linked interface is an internet linked interface.

55. A method for use with a resource scheduling system that includes a schedule that at least one of associates resource time slots with scheduled client matters and associates scheduled recall procedures with schedule times, each scheduled recall procedure for generating at least one recall notice for an associated possible client matter at a corresponding schedule time, each of the scheduled client matters and scheduled recall procedures being a scheduled item, the schedule including scheduled item information associated with each of the scheduled items, the method for facilitating schedule management and comprising the steps of:
for a specific recall procedure, comparing item information with item information associated with the at least a subset of the scheduled items to identify other scheduled items that may be related to the specific recall procedure; and
performing a scheduling process as a function of any identified other schedule items.

56. The method of claim 55 wherein a specific time is associated with the specific recall procedure, the step of comparing including comparing the item information for the specific recall procedure with item information associated with other schedule items that are temporally proximate the specific recall procedure.

57. The method of claim 56 wherein temporally proximate items are within two weeks of the specific time.

58. The method of claim 57 wherein temporally proximate items are within two days of the specific time.

59. The method of claim 55 further including the step of providing an interface and wherein the step of performing a scheduling process includes providing a list of the identified scheduled items via the interface.

60. The method of claim 55 wherein the steps of comparing and performing are performed when item information for the specific recall procedure is initially specified.

61. The method of claim 55 wherein the specific recall procedure is to be performed at a specific time and wherein the steps of comparing and performing are performed when the specific time occurs.

62. The method of claim 55 wherein the steps of comparing and performing are performed on each of the scheduled recall procedures periodically in batch.

63. The method of claim 62 further including the step of providing a scheduling interface and wherein the batch comparing and performing steps are performed each time the scheduling interface is activated.

64. The method of claim 59 wherein the step of providing an interface includes providing an input device enabling an interface user to indicate that the possible recall procedure is related to the identified scheduled item.

65. The method of claim 64 further including the step of receiving an indication that the possible recall procedure is related to the identified scheduled item and updating the schedule so that a single scheduled item is included in the schedule for the possible recall procedure and the single scheduled item pair.

66. The method of claim 55 wherein the specific recall procedure is to be performed at a specific time and wherein the step of comparing the received recall information includes identifying scheduled client matters and recall procedures having time slots and times, respectively, that are temporally proximate the specific time.

67. The method of claim 66 wherein the step of performing a scheduling process includes combining the possible recall procedure with temporally proximate recall procedures and generating a recall notice that indicates possible client matters for each of the combined recall procedures.

68. The method of claim 67 wherein the step of performing a scheduling process also includes generating a recall notice that identifies at least one scheduled client matter temporally proximate the possible recall procedure.

69. The method of claim 55 wherein the step of performing a scheduling process includes printing out a notice that identifies at least a subset of the identified other scheduled items.

70. The method of claim 69 further including the steps of providing an interface and, after the notice is printed, accessing the interface and altering the schedule as a function of the subset of the identified other scheduled items.

71. The method of claim 70 wherein the interface is a network linked interface.

72. The method of claim 71 wherein the interface is linked via the internet.

73. A method for use with a resource scheduling system that includes a resource schedule that associates schedule times for the resource with scheduled client matters and associates scheduled recall procedures with schedule times, each scheduled recall procedure for generating at least one recall notice for an associated possible client matter at a corresponding schedule time, each of the scheduled client matters and scheduled recall procedures being a scheduled item, the method for facilitating schedule management and comprising the steps of:
for a specific recall procedure associated with a specific time, identifying other scheduled items that are associated with times that are temporally proximate the specific time; and
generating at least one recall procedure notice as a function of the identified scheduled items.

74. The method of claim 73 wherein, when at least one of the identified scheduled items is a recall procedure in addition to the specific recall procedure, the step of generating a notice includes generating a single notice for both of the specific recall procedure and the identified recall procedure.

75. The method of claim 74 wherein the step of generating a single notice includes, for each of the identified recall procedures and the specific recall procedure, examining the schedule to identify possible time slots in which appointments can be scheduled and generating a single notice that suggests the possible time slots.

76. The method of claim 75 wherein the step of identifying possible time slots includes identifying temporally proximate time slots.

77. The method of claim 73 wherein, when at least one of the identified scheduled items is a scheduled client matter, the step of generating a notice includes generating a single notice that suggests that an appointment associated with the specific recall procedure may be scheduled temporally proximate an existing scheduled client matter.

78. The method of claim 77 wherein the step of generating a single notice includes, for the specific recall procedure, examining the schedule to identify possible time slots in which appointments can be scheduled and generating a single notice that suggests a possible time slot for the appointment.

79. The method of claim 74 wherein the specific recall procedure associated with the specific time corresponds to a first client and the first client is related to at least a second client, the step of identifying other scheduled items that are associated with times that are temporally proximate the specific time including identifying other scheduled items that are associated with at least one of the first and the second client.

80. A method for use with a recall scheduling system that includes a resource schedule that associates scheduled recall procedures with schedule times, each scheduled recall procedure for generating at least one recall notice for an associated possible client matter at a corresponding schedule time, the method for facilitating recall appointment management and comprising the steps of:
for a specific recall procedure associated with a specific time, identifying other scheduled recall procedures that are associated with times that are temporally proximate the specific time; and
generating at least one recall procedure notice as a function of the identified recall procedures.

81. A method for use with a recall scheduling system that includes a schedule that at least one of associates scheduled recall procedures with schedule times, each scheduled recall procedure for generating at least one recall notice at a corresponding schedule time indicating a possible client matter to be scheduled, the schedule including scheduled recall information associated with each of the scheduled recall procedures, the method for facilitating recall appointment management and comprising the steps of:
receiving recall information for a possible recall procedure that may be scheduled;
comparing the received recall information with at least a subset of the scheduled recall information to identify at least one scheduled recall procedure that may be related to the possible recall procedure; and
performing a scheduling process as a function of the at least one identified scheduled recall procedure.

82. A method for use with a recall system that processes recall procedures, each recall procedure generating at least one recall notice for an associated possible client matter at a corresponding schedule time, the method for use with an electronic network including at least one interface and comprising the steps of:
transmitting at least one recall notice to the interface;
examining the recall notice via the interface;
using the interface to indicate that a matter associated with the recall procedure has likely been completed; and
performing a scheduling function in response to the indication that the matter associated with the recall procedure has been completed.

83. The method of claim 82 wherein the scheduling function includes obtaining authorization via the interface to obtain a confirmation record regarding the completed matter.

84. The method of claim 82 wherein the scheduling function includes storing an indication that the matter associated with the recall procedure has been completed.

85. The method of claim 82 wherein the step of providing an interface includes providing a network linked interface.

86. The method of claim 85 wherein the network linked interface is an internet linked interface.

87. An apparatus for use with a resource scheduling system that includes a schedule that at least one of associates resource time slots with scheduled client matters and associates scheduled recall procedures with schedule times, each scheduled recall procedure for generating at least one recall notice at a corresponding schedule time indicating a possible client matter to be scheduled, each of the scheduled client matters and scheduled recall procedures being a scheduled item, the schedule including scheduled item information associated with each of the scheduled items, the apparatus for facilitating schedule management and comprising:
a processor programmed to perform the steps of:
receiving recall information for a possible recall procedure that may be scheduled;
comparing the received recall information with at least a subset of the scheduled item information to identify at least one scheduled item that may be related to the possible recall procedure; and
performing at least a portion of a scheduling process as a function of the at least one identified scheduled item.

88. The apparatus of claim 87 further including an interface and wherein the processor performs a scheduling process by indicating the at least one identified scheduled item via the interface.

89. The apparatus of claim 88 wherein the interface includes an input device enabling an interface user to indicate that the possible recall procedure is duplicative with the at least one identified scheduled item.

90. The apparatus of claim 89 wherein the interface is an internet linked interface.

91. The apparatus of claim 87 wherein the processor compares by identifying a plurality of scheduled items where each identified scheduled item is associated with information that is similar to the received information and wherein the processor performs a scheduling process includes performing a scheduling process as a function of the plurality of identified scheduled items.
